(19) United States
(12) Patent Application Publication
(10) Pub. No.: US 2020/0074978 A1
(43) Pub. Date: Mar. 5, 2020

(54) SIGNAL PROCESSING DEVICE AND METHOD, AND PROGRAM

(71) Applicant: Sony Corporation, Tokyo (JP)

(72) Inventors: Yu Maeno, Tokyo (JP); Yuhki Mitsufuji, Tokyo (JP)

(73) Assignee: Sony Corporation, Tokyo (JP)

(21) Appl. No.: 16/490,124

(22) PCT Filed: Feb. 21, 2018
(86) PCT No.: PCT/JP2018/006112

§ 371 Date: Aug. 30, 2019

(30) Foreign Application Priority Data
Mar. 7, 2017 (JP) 2017-042680

(51) Int. Cl. G10K 11/178; H04R 1/40; H04R 3/00; H04R 3/12

(52) U.S. Cl. CPC G10K 11/17854; H04R 1/406; H04R 1/403; G10K 2210/3046; H04R 3/12; G10K 11/17881; G10K 2210/3028; H04R 3/005

(57) ABSTRACT

The present technology relates to a signal processing device and method, and a program that are capable of improving noise canceling performance.

A signal processing device includes: a noise detection unit that detects control area internal noise generated in a control area formed by a microphone array; and a control unit that controls update of a filter coefficient of an adaptive filter, used to generate a signal of an output sound output by a speaker array, on the basis of a detection result of the control area internal noise in order to reduce external noise to a noise canceling area formed by the speaker array. The present technology can be applied to a spatial noise control device.

### TECHNICAL FIELD

The present technology relates to a signal processing device and method, and a program, and more particularly, to a signal processing device and method, and a program that are capable of improving noise canceling performance.

### BACKGROUND ART

Noise canceling technologies have been studied for a long time, and headphones equipped with a noise canceling function have been put to practical use and are now widespread.

In recent years, studies have been conducted regarding a method of using a large number of speakers and microphones to surround a control area and suppress noise in a wider area, as the noise canceling technology. It is considered that such a method can keep a wide area quiet in, for example, a car or an aircraft.

Typically, an adaptive filter is generally used in noise canceling because a frequency characteristic of noise is unknown.

A noise signal acquired by a reference microphone or an error microphone is required to update a coefficient of the adaptive filter. It is typically assumed that noise input to these microphones intrudes into a control area from the outside of the control area. However, it is also conceivable that noise is unintentionally generated inside the control area and collected by the microphone.

If the noise generated inside the control area is detected by the reference microphone or the error microphone in this manner, the adaptive filter diverges so that noise canceling performance is degraded.

Thus, a method of using a unidirectional microphone as a reference microphone or an error microphone is proposed (for example, see Non-Patent Document 1).

In this method, a directivity of the microphone is directed to the outside of a control area, and thus, it is possible to ideally remove influence from noise arriving from the inside of the control area.

### CITATION LIST

### Patent Document

Non-Patent Document 1: Christian Kleinhenrich, Detlef Krahe, “The Reflection Equivalence Formulation for a circular ANC System”, Proceedings of INTER-NOISE 2016. 2016.

### SUMMARY OF THE INVENTION

### Problems to be Solved by the Invention

However, it is difficult to obtain sufficient noise canceling performance with the above-described technology.

For example, in the method using the unidirectional microphone, it is difficult to actually create a microphone having a perfect unidirectionality, and the influence of noise transmitted from the inside of the control area is received to some extent.

Furthermore, it is difficult to keep frequency characteristics flat with the microphone having the unidirectionality, and thus, not only a gain in a low band generally decreases but also a variation between individual microphones is large, whereby it is difficult to accurately record a sound field. Thus, the noise canceling performance is degraded in some cases.

The present technology has been made in view of such a situation, and aims to enable noise canceling performance to be improved.

### Solutions to Problems

A signal processing device according to one aspect of the present technology includes: a noise detection unit that detects control area internal noise generated in a control area formed by a microphone array; and a control unit that controls update of a filter coefficient of an adaptive filter, used to generate a signal of an output sound output by a speaker array, on the basis of a detection result of the control area internal noise in order to reduce external noise to a noise canceling area formed by the speaker array.

The signal processing device can be further provided with an adaptive filter unit that generates the signal of the output sound on the basis of a signal obtained by sound collection using the microphone array and the filter coefficient.

It is possible to cause the adaptive filter unit to perform a filtering process based on the signal obtained by the sound collection using the microphone array and the filter coefficient in a spatial frequency domain so as to generate the signal of the output sound.

It is possible to cause the control unit not to perform the update of the filter coefficient in a case where the noise detection unit detects the control area internal noise.

It is possible to cause the noise detection unit to detect the control area internal noise on the basis of the signal obtained by the sound collection using the microphone array.

It is possible to cause the noise detection unit to detect the control area internal noise on the basis of each of signals obtained by sound collection using each of a plurality of microphone arrays which constitutes the microphone array and has different distances from a center position of the control area.

It is possible to cause the noise detection unit to detect the control area internal noise on the basis of the signal obtained by the sound collection using the microphone array and a signal obtained by sound collection by another microphone array different from the microphone array in a distance from a center position of the control area.

It is possible to cause the noise detection unit to detect the control area internal noise on the basis of a signal obtained by sound collection using a detection microphone arranged in the control area.

It is possible to cause the microphone array to be obtained by arranging a plurality of microphone arrays in a predetermined shape.

It is possible to cause the speaker array to be obtained by arranging a plurality of speaker arrays in a predetermined shape.

It is possible to make the control area as an area formed using a reference microphone array or an error microphone array as the microphone array.

A signal processing method or a program according to one aspect of the present technology includes the steps of: detecting control area internal noise generated in a control area formed by a microphone array; and controlling update of a filter coefficient of an adaptive filter, used to generate a signal of an output sound output by a speaker array, on the basis of a detection result of the control area internal noise in order to reduce external noise to a noise canceling area formed by the speaker array.

According to one aspect of the present technology, control area internal noise generated in a control area formed by a microphone array is detected, and update of a filter coefficient of an adaptive filter, used to generate a signal of an output sound output by a speaker array, is controlled on the basis of a detection result of the control area internal noise in order to reduce external noise to a noise canceling area formed by the speaker array.

### EFFECTS OF THE INVENTION

According to one aspect of the present technology, it is possible to improve the noise canceling performance.

Note that the effects described herein are not necessarily limited, and may be any of effects described in the present disclosure.

### BRIEF DESCRIPTION OF DRAWINGS

FIG. 1 is a view illustrating the present technology.

FIG. 2 is a diagram for describing a feedforward ANC system.

FIG. 3 is a diagram illustrating a configuration example of a spatial noise control device.

FIG. 4 is a diagram for describing a coordinate system.

FIG. 5 is a view for describing a control area.

FIG. 6 is a flowchart illustrating a noise canceling process.

FIG. 7 is a diagram illustrating a configuration example of a spatial noise control device.

FIG. 8 is a view for describing a control area.

FIG. 9 is a flowchart illustrating a noise canceling process.

FIG. 10 is a view for describing other examples of a reference microphone array, a speaker array, and an error microphone array.

FIG. 11 is a view for describing other examples of the reference microphone array, the speaker array, and the error microphone array.

FIG. 12 is a view for describing other examples of the speaker array and the error microphone array.

FIG. 13 is a view for describing other examples of the speaker array and the error microphone array.

FIG. 14 is a view for describing other examples of the reference microphone array and the error microphone array.

FIG. 15 is a view for describing another example of the speaker array.

FIG. 16 is a view for describing other examples of the reference microphone array, the speaker array, and the error microphone array.

FIG. 17 is a view for describing another example of the reference microphone array.

FIG. 18 is a view for describing another example of the error microphone array.

FIG. 19 is a diagram illustrating an exemplary configuration of a computer.

### MODE FOR CARRYING OUT THE INVENTION

Hereinafter, embodiments to which the present technology is applied will be described with reference to the drawings. 31

### First Embodiment

<Regarding Present Technology>

The present technology prevents a divergence of an adaptive filter even in a case where noise occurs inside a control area and enables noise canceling performance to be improved by detecting the noise generated inside the control area and controlling update of the adaptive filter according to the detection result.

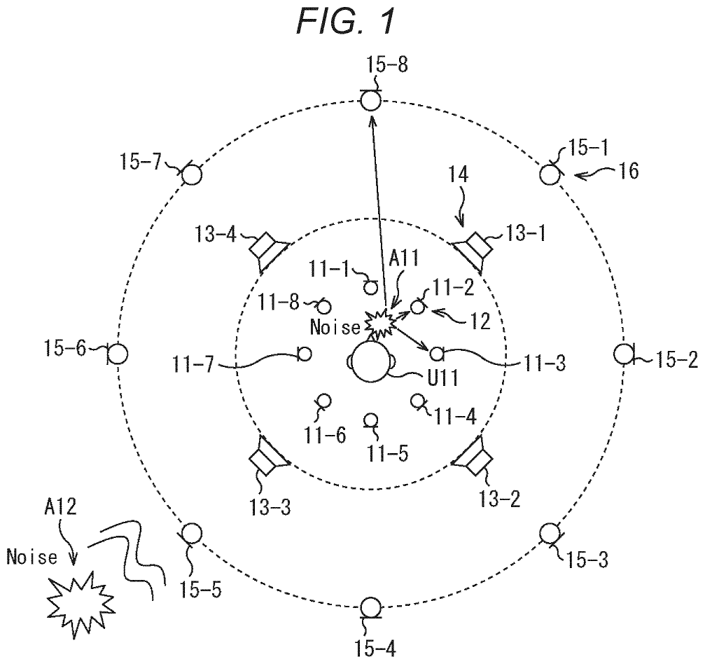

First, an overview of noise canceling to which the present technology is applied will be described with reference to FIG. 1.

In an example illustrated in FIG. 1, error microphones 11-1 to 11-8 are arranged in a ring shape so as to surround a position where a predetermined user U11 is present, and these error microphones 11-1 to 11-8 constitute an error microphone array 12.

Note that the error microphones 11-1 to 11-8 will be simply referred to as error microphones 11 in a case where it is unnecessary to particularly distinguish the error microphones 11-1 to 11-8.

Furthermore, the speakers 13-1 to 13-4 are arranged in a ring shape so as to surround the error microphone array 12, and the speakers 13-1 to 13-4 constitute a speaker array 14.

Hereinafter, the speakers 13-1 to 13-4 will be also simply referred to as speakers 13 in a case where it is unnecessary to distinguish the speakers 13-1 to 13-4.

Moreover, reference microphones 15-1 to 15-8 are arranged in a ring shape so as to surround the speaker array 14, and the reference microphones 15-1 to 15-8 constitute a reference microphone array 16.

Note that the reference microphones 15-1 to 15-8 will be simply referred to as reference microphones 15 hereinafter in a case where it is unnecessary to particularly distinguish the reference microphones 15-1 to 15-8.

In this example, an area surrounded by the error microphones 11, in other words, an area inside the error microphone array 12, or an area surrounded by the reference microphones 15, in other words, an area inside the reference microphone array 16 is set as a control area to be subjected to noise detection.

Here, assuming that noise (a sound), which is generated in the control area and propagates to the outside of the control area, for example, a position indicated by an arrow A11 or the like, is referred to as control area internal noise, the control area is an area to be subjected to the control area internal noise detection The control area internal noise is generated, for example, when the user U11 speaks or moves his/her body.

On the other hand, noise (a sound), which is generated outside the control area and propagates to the inside of the control area, for example, a position indicated by an arrow A12 or the like, is referred to as external noise. The external noise is a sound to be subjected to noise canceling, and in particular, a propagation path of the external noise from an external noise source to the error microphone 11 is called a primary path.

Furthermore, in this example, an area surrounded by the speakers 13, in other words, an area inside the speaker array 14 is the area to be subjected to noise canceling, and this area will be also referred to as a noise canceling area hereinafter.

During the noise canceling, the speaker array 14 outputs a sound that counteracts noise, especially external noise so that noise is reduced (canceled) in the noise canceling area, thereby realizing the noise canceling. In this case, the external noise is particularly canceled, and the control area internal noise is not subjected to reduction (cancellation).

Note that a propagation path of a sound output from the speaker 13 to the error microphone 11, that is, the propagation path between the speaker 13 and the error microphone 11 is called a secondary path.

For example, an adaptive filter is used for noise canceling. This is because the external noise to be subjected to the canceling is not known noise determined in advance.

During update of a filter coefficient of the adaptive filter, the filter coefficient is calculated on the basis of a reference signal obtained by collecting a sound by the reference microphone array 16 and an error signal obtained by collecting a sound by the error microphone array 12.

Here, the reference signal is a signal mainly including an external noise component, and the error signal is a signal mainly indicating a difference between a component of the sound output from the speaker array 14 and the external noise component.

The speaker array 14 outputs a sound based on a signal obtained by a filtering process on the reference signal using the filter coefficient obtained in this manner, and the external noise is reduced by such a sound.

As described above, the control area internal noise caused by the user U11 or the like is generated in the control area. The control area internal noise is noise that propagates from the inside of the control area to the outside of the control area, and a propagation direction is opposite to a propagation direction of the sound output from the speaker 13, and thus, the control thereof is difficult. In other words, for example, it is difficult to cancel the control area internal noise in the entire control area by the sound output from the speaker array 14 or cancel the control area internal noise only in an area near the error microphone 11.

If such control area internal noise is mixed into the error microphone 11 and the reference microphone 15 from an unintended direction, there is even a possibility that the adaptive filter diverges so that it is difficult to obtain an appropriate filter coefficient.

Therefore, in the present technology, the control area internal noise is detected, and a process of updating the adaptive filter, that is, an adaptive process is stopped when the control area internal noise is detected so as to improve noise canceling performance.

<Regarding ANC>

Hereinafter, the present technology will be described more specifically.

First, a general feedforward active noise control (ANC) system will be described.

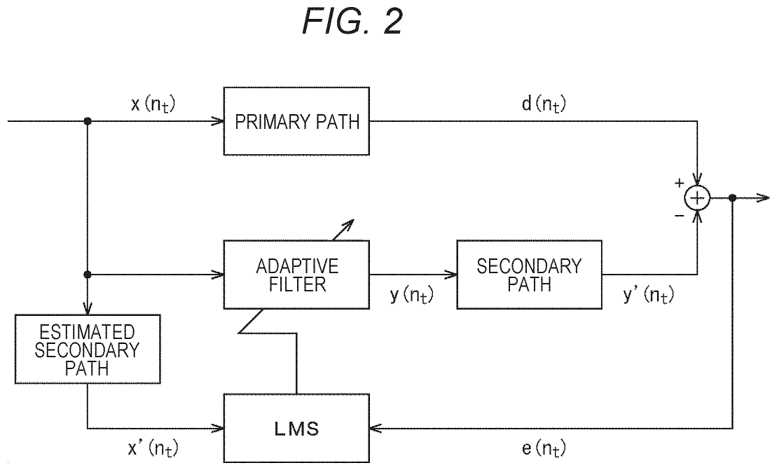

FIG. 2 illustrates a block diagram of the general feedforward ANC system.

In the feedforward ANC system, a filter coefficient of the adaptive filter is determined by least mean squares (LMS) on the basis of a signal x′(nₜ), obtained by multiplying a reference signal x(nₜ) obtained by the reference microphone by an estimated secondary path, which is an estimated value of the secondary path, and an error signal e(nₜ).

Then, in the adaptive filter, the filtering process is performed on the reference signal x(nₜ) using the filter coefficient obtained by LMS, and a noise canceling sound is output from the speaker on the basis of the obtained signal. A signal y(nₜ) of the sound output from the speaker passes through the secondary path to become a signal y′(nₜ) and is collected by the error microphone. At the same time, the reference signal x(nₜ), which is external noise, also passes through the primary path to become a signal d(nₜ) and is collected by the error microphone.

The signal including the signal d(nₜ) and the signal y′(nₜ) collected by the error microphone in this manner becomes a new error signal e(nₜ), and this error signal e(nₜ) is supplied to LMS.

Such an ANC system is particularly called a Filtered-X LMS algorithm. Note that the Filtered-X LMS algorithm is described in detail in, for example, “Morgan D. R., “An analysis of multiple correlation cancellation loops with a filter in the auxiliary path”, IEEE Trans. Acoust. Speech Signal Process., ASSP28(4), 454-467, 1980”. and the like.

Here, assuming that an angular frequency is ω, an error signal, a primary path, a secondary path, a filter coefficient of the adaptive filter, and a reference signal in a time frequency domain are E(ω), P(ω), S(ω), W(w), and X(ω), respectively, the error signal E(ω) is expressed by the following Formula (1).

[Formula 1]

E(ω)=[P(ω)−S(ω)W(ω)]X(ω) (1)

Ideally, noise is completely canceled (removed) when the error signal E(ω)=0, and thus, an ideal filter coefficient W_{ideal}(ω) of the adaptive filter is expressed by the following Formula (2).

$$\begin{matrix}[ Formula 2 ] & \\ {W}_{ideal} ( ω ) = \frac{P ( ω )}{S ( ω )} & ( 2 )\end{matrix}$$

However, since it is difficult to obtain the filter coefficient of the adaptive filter in consideration of the secondary path S(ω) itself without delay, a secondary path model S′(ω), which is an estimated value of the secondary path, is used to update the filter coefficient.

When considered in the time domain, the error signal e(nₜ) is expressed by the following Formula (3).

[Formula 3]

e(nₜ)=d(nₜ)−s(nₜ)*[w^{T}(nₜ)×(nₜ)] (3)

Note that, in Formula (3), nₜ indicates a time index, d(nₜ) indicates a signal of external noise collected by the error microphone through the primary path, and s(nₜ) indicates an impulse response of the secondary path S(ω). Furthermore, in Formula (3), * indicates a linear convolution operation, w(nₜ) indicates a filter coefficient of the adaptive filter, and x(nₜ) indicates a reference signal.

The filter coefficient w(nₜ) of the adaptive filter is updated so as to minimize a squared error ξ′(nₜ) of the error signal e(nₜ) as expressed by the following Formula (4).

[Formula 4]

ξ′(nₜ)=e²(nₜ) (4)

For example, if using the steepest descent method, the filter coefficient of the adaptive filter can be updated as expressed by the following Formula (5).

$$\begin{matrix}[ Formula 5 ] & \\ w ( {n}_{t} + 1 ) = w ( {n}_{t} ) - \frac{μ}{2} ∇ {ξ}^{′} ( {n}_{t} ) & ( 5 )\end{matrix}$$

Note that, in Formula (5), w(nₜ) indicates the filter coefficient before update, and w(nₜ+1) indicates a filter coefficient after update. Furthermore, p indicates a step size, and ∇ξ(nₜ) indicates a gradient of the squared error of the error signal e(nₜ) in the Formula (5).

Here, the gradient ∇ξ′(nₜ) of the squared error is expressed as in the following Formula (6).

[Formula 6]

∇ξ′(nₜ)=−2x′(nₜ)e(nₜ) (6)

Note that x′(nₜ) in Formula (6) is expressed by the following Formula (7). In Formula (7), s′(nₜ) indicates an impulse response of the secondary path model S′(ω).

[Formula 7]

x′(nₜ)=s′(nₜ)*x(nₜ) (7)

When the Formula (6) is substituted into the above Formula (5), an update equation of the filter coefficient w(nₜ) expressed by the following Formula (8) is obtained.

[Formula 8]

w(nₜ+1)=w(nₜ)+μx′(nₜ)e(nₜ) (8)

In the feedforward ANC system, the update equation illustrated in Formula (8) is used to update the filter coefficient of the adaptive filter.

<Configuration Example of Spatial Noise Control Device>

Next, a specific embodiment in which the present technology is applied to a feedforward ANC system will be described.

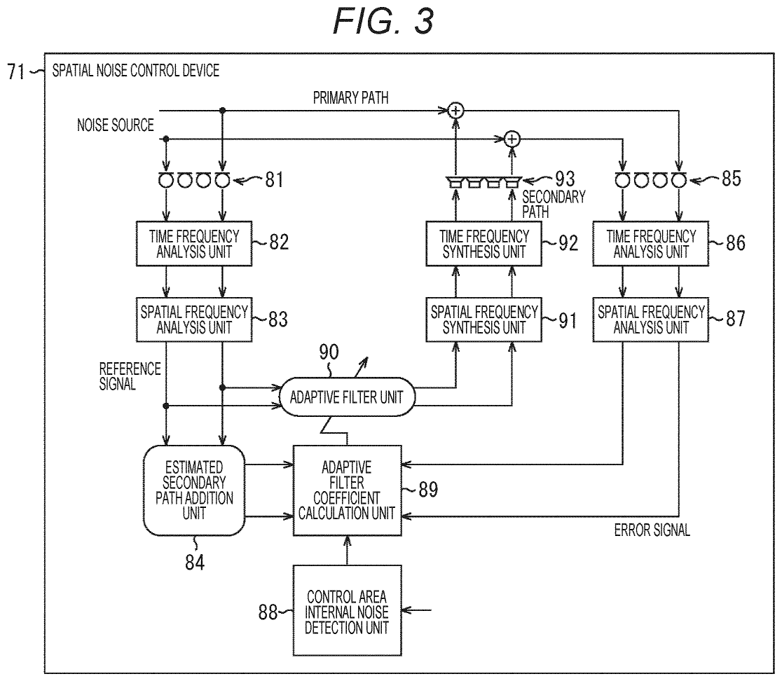

FIG. 3 is a diagram illustrating a configuration example of an embodiment of a spatial noise control device to which the present technology is applied.

A spatial noise control device 71 is a signal processing device that updates a filter coefficient of an adaptive filter using the feedforward ANC system and uses the obtained filter coefficient to realize noise canceling in a noise canceling area.

The spatial noise control device 71 includes a reference microphone array 81, a time frequency analysis unit 82, a spatial frequency analysis unit 83, an estimated secondary path addition unit 84, an error microphone array 85, a time frequency analysis unit 86, a spatial frequency analysis unit 87, a control area internal noise detection unit 88, an adaptive filter coefficient calculation unit 89, an adaptive filter unit 90, a spatial frequency synthesis unit 91, a time frequency synthesis unit 92, and a speaker array 93.

The reference microphone array 81 corresponds to, for example, the reference microphone array 16 illustrated in FIG. 1 and is a microphone array obtained by arranging a plurality of microphones in a ring shape or a spherical shape. The reference microphone array 81 collects a sound of the outside, and supplies a reference signal obtained as a result to the time frequency analysis unit 82. Note that the reference signal is an audio signal mainly including a component of external noise generated from a noise source.

The time frequency analysis unit 82 performs time frequency transform on the reference signal supplied from the reference microphone array 81, and supplies a time frequency spectrum of the reference signal obtained as a result to the spatial frequency analysis unit 83.

The spatial frequency analysis unit 83 performs spatial frequency transform on the time frequency spectrum of the reference signal supplied from the time frequency analysis unit 82, and supplies a spatial frequency spectrum of the reference signal obtained as a result to the estimated secondary path addition unit 84 and the adaptive filter unit 90.

The estimated secondary path addition unit 84 multiplies the spatial frequency spectrum of the reference signal supplied from the spatial frequency analysis unit 83 by the spatial frequency spectrum of the estimated secondary path, which is the estimated value of the secondary path, that is, the secondary path model, and supplies the spatial frequency spectrum obtained as a result to the adaptive filter coefficient calculation unit 89.

The error microphone array 85 corresponds to, for example, the error microphone array 12 illustrated in FIG. 1 and is a microphone array obtained by arranging a plurality of microphones in a ring shape or a spherical shape. The error microphone array 85 collects a sound of the outside, and supplies an error signal obtained as a result to the time frequency analysis unit 86.

Note that the error signal is an audio signal mainly including a component of external noise generated from a noise source and a component of sound output from the speaker array 93.

Here, the sound output from the speaker array 93 is a sound that counteracts, that is, cancels the external noise. Therefore, it is possible to say that the error signal indicates an error between a component of the external noise which has not been counteracted at the time of noise canceling, that is, external noise and the sound output from the speaker array 93.

The time frequency analysis unit 86 performs time frequency transform on the error signal supplied from the error microphone array 85, and supplies a time frequency spectrum of the error signal obtained as a result to the spatial frequency analysis unit 87.

The spatial frequency analysis unit 87 performs spatial frequency transform on the time frequency spectrum of the error signal supplied from the time frequency analysis unit 86, and supplies a spatial frequency spectrum of the error signal obtained as a result to the adaptive filter coefficient calculation unit 89.

The control area internal noise detection unit 88 detects control area internal noise generated in a control area on the basis of, for example, a sensor signal which is an output of a sensor such as a camera arranged in the control area and a sound collection signal or the like which is an output of a detection microphone arranged in the control area. Furthermore, the control area internal noise detection unit 88 supplies a noise detection signal indicating a detection result of the control area internal noise to the adaptive filter coefficient calculation unit 89.

The adaptive filter coefficient calculation unit 89 functions as a control unit that controls update of the filter coefficient of the adaptive filter on the basis of the noise detection signal supplied from the control area internal noise detection unit 88.

In other words, the adaptive filter coefficient calculation unit 89 calculates the filter coefficient of the adaptive filter on the basis of the spatial frequency spectrum from the estimated secondary path addition unit 84 and the spatial frequency spectrum of the error signal from the spatial frequency analysis unit 87 according to the noise detection signal, and supplies the calculated filter coefficient to the adaptive filter unit 90. The filter coefficient of the adaptive filter obtained by the adaptive filter coefficient calculation unit 89 is ideally a filter coefficient of a filter having inverse characteristics of a secondary path.

Such a filter coefficient of the adaptive filter is used to generate a speaker drive signal of an output sound to be output from the speaker array 93 in order to reduce, in other words, cancel (counteract) the external noise in the noise canceling area.

The adaptive filter unit 90 uses the filter coefficient of the adaptive filter supplied from the adaptive filter coefficient calculation unit 89 to performs a filtering process on the spatial frequency spectrum of the reference signal supplied from the spatial frequency analysis unit 83, and supplies a spatial frequency spectrum of the speaker drive signal obtained as a result to the spatial frequency synthesis unit 91. In this case, the adaptive filter unit 90 performs the filtering process based on the reference signal and the filter coefficient in a spatial frequency domain to generate the speaker drive signal.

The spatial frequency synthesis unit 91 performs spatial frequency synthesis of the spatial frequency spectrum supplied from the adaptive filter unit 90, and supplies a time frequency spectrum of the speaker drive signal obtained as a result to the time frequency synthesis unit 92.

The time frequency synthesis unit 92 performs time frequency synthesis of the time frequency spectrum of the speaker drive signal supplied from the spatial frequency synthesis unit 91, and supplies a speaker drive signal, which is a time signal obtained as a result, to the speaker array 93.

The speaker array 93 corresponds to, for example, the speaker array 14 illustrated in FIG. 1, and is a speaker array obtained by arranging a plurality of speakers in a ring shape or a spherical shape. The speaker array 93 outputs a sound on the basis of the speaker drive signal supplied from the time frequency synthesis unit 92.

Note that an arrangement relationship among the reference microphone array 81, the error microphone array 85, and the speaker array 93 is, for example, the same as an arrangement relationship among the reference microphone array 16, the error microphone array 12, and the speaker array 14 in FIG. 1.

In other words, the speaker array 93 is arranged so as to surround the periphery of the error microphone array 85, and the reference microphone array 81 is arranged so as to surround the speaker array 93.

Note that, here, an area formed by the reference microphone array 81, in other words, an area surrounded by the reference microphone array 81 is set as the control area although details will be described later. Furthermore, an area formed by the speaker array 93, in other words, an area surrounded by the speaker array 93 is set as the noise canceling area.

Here, the respective units constituting the spatial noise control device 71 will be described in more detail.

(Time Frequency Analysis Unit) First, the time frequency analysis unit 82 will be described.

In the time frequency analysis unit 82, time frequency transform is performed on a reference signal s(q, nₜ) obtained by sound collection of the microphones constituting the reference microphone array 81.

In other words, the time frequency analysis unit 82 performs the time frequency transform using discrete Fourier transform (DFT) by performing calculation of the following Formula (9), thereby obtaining a time frequency spectrum S (q, n_{tf}) from the reference signal s (q, nₜ).

$$\begin{matrix}[ Formula 9 ] & \\ S ( q , {n}_{tf} ) = {\sum }_{{n}_{t} = 0}^{{M}_{t} - 1} s ( q , {n}_{t} ) {e}^{- i \frac{2 π {n}_{tf} {n}_{t}}{{M}_{t}}} & ( 9 )\end{matrix}$$

Note that, in Formula (9), q represents a microphone index to identify a microphone constituting the reference microphone array 81, and q=0, 1, 2, . . . , and Q−1. Furthermore, Q indicates a microphone number which is the number of microphones constituting the reference microphone array 81, and nₜ indicates a time index. Moreover, n_{tf} indicates a time frequency index, Mₜ indicates the number of DFT samples, and i indicates a pure imaginary number.

The time frequency analysis unit 82 supplies the time frequency spectrum S(q, n_{tf}) obtained by the time frequency transform to the spatial frequency analysis unit 83.

Note that even in the time frequency analysis unit 86, calculation similar to that in the case of the time frequency analysis unit 82 is performed to perform time frequency transform on the error signal.

(Spatial Frequency Analysis Unit)

The spatial frequency analysis unit 83 performs spatial frequency analysis of the time frequency spectrum S(q, n_{tf}) supplied from the time frequency analysis unit 82 according to a shape of the reference microphone array 81, in other words, an arrangement shape of the microphones constituting the reference microphone array 81. In other words, spatial frequency transform is performed on the time frequency spectrum S (q, n_{tf}).

For example, in a case where the reference microphone array 81 is a circular microphone array, the following Formula (10) is calculated to perform the spatial frequency transform.

$$\begin{matrix}[ Formula 10 ] & \\ {S}^{′} = \frac{1}{Q} {J}_{inv} {E}_{mic}^{H} S & ( 10 )\end{matrix}$$

Note that, in Formula (10), S′ indicates a vector of the spatial frequency spectrum, Q indicates the number of microphones of the reference microphone array 81, and Jᵢₙᵥ indicates a matrix including a spherical Bessel function.

Furthermore, E_{mic} indicates a matrix including a circular harmonic function, E^{H}_{mic} indicates a Hermitian transposed matrix of the matrix E_{mic}, S indicates a vector of the time frequency spectrum S(q, n_{tf}) of the reference signal.

Specifically, the vector S′ of the spatial frequency spectrum is expressed by the following Formula (11).

$$\begin{matrix}[ Formula 11 ] & \\ {S}^{′} = [ \begin{matrix}{S}_{- N}^{′ } ( {n}_{tf} ) \\ {S}_{- N + 1}^{′ } ( {n}_{tf} ) \\ {S}_{- N + 2}^{′ } ( {n}_{tf} ) \\ ⋮ \\ {S}_{N}^{′ } ( {n}_{tf} )\end{matrix} ] & ( 11 )\end{matrix}$$

In Formula (11), S′n(n_{tf}) (where n=−N, −N+1, . . . , and N) indicates a spatial frequency spectrum of the reference signal. In the spatial frequency spectrum S′n (n_{tf}), n indicates the order of a spatial frequency, and in particular, N indicates the maximum order of the spatial frequency. Furthermore, n_{tf} in the Formula (11) indicates the time frequency index.

Moreover, the matrix Jᵢₙᵥ including the spherical Bessel function in the Formula (10) is, for example, expressed by the following Formula (12), and the matrix E_{mic} including the circular harmonic function is expressed by the following Formula (13).

$$\begin{matrix}[ Formula 12 ] & \\ {J}_{inv} = [ \begin{matrix}1 \text{/} {j}_{- N} ( \frac{ω}{c} {r}_{mic} ) & 0 & … & 0 \\ 0 & 1 \text{/} {j}_{- N + 1} ( \frac{ω}{c} {r}_{mic} ) & … & 0 \\ ⋮ & ⋮ & ⋱ & ⋮ \\ 0 & 0 & … & 1 \text{/} {j}_{N} ( \frac{ω}{c} {r}_{mic} )\end{matrix} ] & ( 12 ) \\ [ Formula 13 ] & \\ {E}_{mic} = [ \begin{matrix}{e}^{i ( - N ) {φ}_{0}} & {e}^{i ( - N + 1 ) {φ}_{0}} & … & {e}^{iN {φ}_{0}} \\ {e}^{i ( - N ) {φ}_{1}} & {e}^{i ( - N + 1 ) {φ}_{1}} & … & {e}^{iN {φ}_{1}} \\ ⋮ & ⋮ & ⋱ & ⋮ \\ {e}^{i ( - N ) {φ}_{Q - 1}} & {e}^{i ( - N + 1 ) {φ}_{Q - 1}} & … & {e}^{iN {φ}_{Q - 1}}\end{matrix} ] & ( 13 )\end{matrix}$$

Note that, in Formula (12), jₙ represents a spherical Bessel function in which the order of the spatial frequency is n, c indicates speed of a sound, r_{mic} indicates a radius of the reference microphone array 81, which is a circular microphone array, and ω indicates an angular frequency.

Furthermore, in Formula (13), i indicates a pure imaginary number, n (where n=−N, −N+1, . . . , and N) indicates the order of the spatial frequency, φq indicates an azimuth angle of a position of a microphone whose microphone index of the reference microphone array 81 is q.

Here, the azimuth angle and an elevation angle of the microphone position will be described.

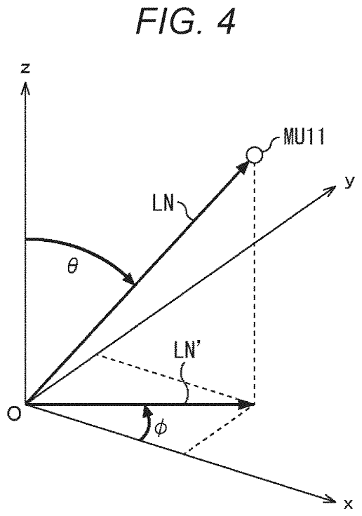

For example, it is assumed to consider a three-dimensional orthogonal coordinate system having an origin O as a reference and an x axis, a y axis, and a z axis as the respective axes as illustrated in FIG. 4.

Here, it is assumed that a straight line connecting a predetermined microphone MU11 of the reference microphone array 81 and the origin O is a straight line LN, and a straight line obtained by projecting the straight line LN from a z-axis direction to an xy plane is a straight line LN′.

At this time, an angle φ between the x axis and the straight line LN′ is an azimuth angle indicating a direction of a position of the microphone MU11 as viewed from the origin O in the xy plane. Furthermore, an angle θ between the z axis and the straight line LN is an elevation angle indicating a direction of a position of the microphone MU11 as viewed from the origin O in a plane perpendicular to the xy plane.

Moreover, the vector S in the above Formula (10) is expressed by the following Formula (14).

$$\begin{matrix}[ Formula 14 ] & \\ S = [ \begin{matrix}S ( 0 , {n}_{tf} ) \\ S ( 1 , {n}_{tf} ) \\ S ( 2 , {n}_{tf} ) \\ ⋮ \\ S ( Q - 1 , {n}_{tf} )\end{matrix} ] & ( 14 )\end{matrix}$$

In Expression (14), the vector S is a vector having the time frequency spectrum S(q, n_{tf}) of the reference signal obtained by each microphone of the reference microphone array 81 as an element.

Furthermore, for example, in a case where the reference microphone array 81 is a spherical microphone array, the following Formula (15) is calculated to perform the spatial frequency transform.

$$\begin{matrix}[ Formula 15 ] & \\ {S}^{′} = \frac{1}{Q} {J}_{inv} {Y}_{mic}^{H} S & ( 15 )\end{matrix}$$

Note that, in Formula (15), S′ is the vector of the spatial frequency spectrum expressed in Formula (11), Q indicates the number of microphones of the reference microphone array 81, and Jᵢₙᵥ is the matrix including the spherical Bessel function expressed in Formula (12).

Furthermore, Y_{mic} is a matrix including a spherical harmonic function, V^{H}_{mic} indicates a Hermitian transposed matrix of the matrix Y_{mic}, S is a vector of the time frequency spectrum S(q, n_{tf}) of the reference signal expressed in Formula (14).

Here, it is assumed that an elevation angle and an azimuth angle of a position of a microphone at which the microphone index of the reference microphone array 81 is q are θ_{q} and φ_{q}, respectively, and a spherical harmonic function in which the order of the spatial frequency is n and m is Yₙ^{m}(θ_{q}, φ_{q}).

In this case, the matrix Y_{mic} including the spherical harmonic function is expressed by the following Formula (16). Note that, in Formula (16), N and M represent the maximum orders of the spatial frequency.

$$\begin{matrix} [ Formula 16 ] & \\ {Y}_{mic} = [ \begin{matrix}{Y}_{0}^{0} ( {θ}_{0} , {φ}_{0} ) & {Y}_{1}^{- 1} ( {θ}_{0} , {φ}_{0} ) & … & {Y}_{N}^{M} ( {θ}_{0} , {φ}_{0} ) \\ {Y}_{0}^{0} ( {θ}_{1} , {φ}_{1} ) & {Y}_{1}^{- 1} ( {θ}_{1} , {φ}_{1} ) & … & {Y}_{N}^{M} ( {θ}_{1} , {φ}_{1} ) \\ ⋮ & ⋮ & … & ⋮ \\ {Y}_{0}^{0} ( {θ}_{Q - 1} , {φ}_{Q - 1} ) & {Y}_{1}^{- 1} ( {θ}_{Q - 1} , {φ}_{Q - 1} ) & … & {Y}_{N}^{M} ( {θ}_{Q - 1} , {φ}_{Q - 1} )\end{matrix} ] & ( 16 )\end{matrix}$$

The spatial frequency analysis unit 83 outputs the spatial frequency spectrum S′ₙ(n_{tf}) obtained by the spatial frequency transform expressed in the Formula (10) or the Formula (15). Note that, even in the spatial frequency analysis unit 87, the spatial frequency transform (spatial frequency analysis) is performed by calculation similar to that in the case of the spatial frequency analysis unit 83.

(Control Area Internal Noise Detection Unit)

The control area internal noise detection unit 88 detects control area internal noise and generates a noise detection signal indicating the detection result.

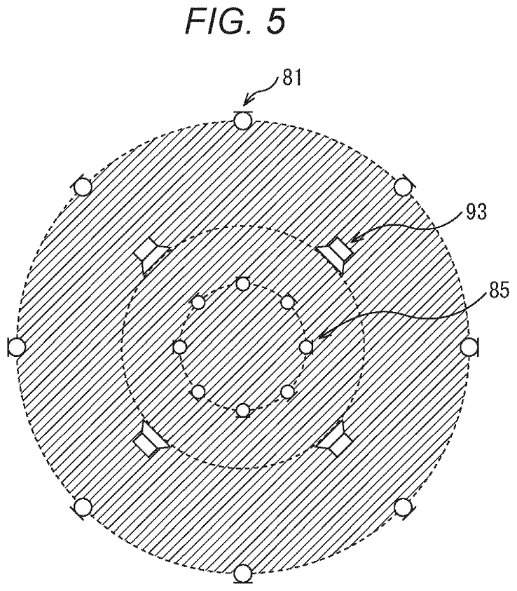

Here, the control area is, for example, an area formed by the reference microphone array 81 as illustrated in FIG. 5, in other words, an area surrounded by the reference microphone array 81. Note that parts in FIG. 5 corresponding to those of the case in FIG. 3 will be denoted by the same reference signs, and the description thereof will be omitted as appropriate.

In the example illustrated in FIG. 5, the speaker array 93 and the error microphone array 85 are arranged in the area surrounded by the microphones of the reference microphone array 81.

In the spatial noise control device 71, an inner part of the reference microphone array 81 with hatching, that is, an area of a part surrounded by the respective microphones is set as the control area, and noise (a sound) generated in this control area is detected.

For example, the control area internal noise detection unit 88 detects a user in the control area on the basis of a sensor signal output from a camera that captures the control area as a subject, in other words, image data, and detects a motion of the user's mouth.

Then, the control area internal noise detection unit 88 generates a noise detection signal indicating that control area internal noise has been detected when the motion of the user's mouth has been detected, and generates a noise detection signal indicating that no control area internal noise has been detected when the motion of the user's mouth has not been detected

Furthermore, the control area internal noise detection unit 88 may detect the control area internal noise on the basis of sound collection signals output from one or a plurality of detection microphones, for example, by installing the detection microphone in the control area or attaching the detection microphone to the user in the control area.

In this case, for example, the control area internal noise detection unit 88 is only required to detect presence or absence of control area internal noise from a temporal change in sound pressure of a sound based on the sound collection signal.

Moreover, the control area internal noise may be detected on the basis of a sound pressure ratio of a sound based on signals output from two microphones, for example, using two arbitrary microphones among the detection microphone, the reference microphone array 81, and the error microphone array 85 installed at positions different from each other. In this case, the sound pressure and the like of the sound based on the signals output from the two microphones are compared in advance, and the comparison result may be appropriately used for noise detection.

For example, in a case where the control area internal noise is detected using the reference microphone array 81 and the error microphone array 85, sound pressures obtained at the reference microphone array 81 and the error microphone array 85 are different between when the control area internal noise is collected and when the external noise is collected. In other words, for example, when the control area internal noise is collected, the sound pressure at the error microphone array 85 is to be larger than the sound pressure at the reference microphone array 81, and thus, the control area internal noise is only required to be detected by utilizing such a relationship of the sound pressures.

In this manner, it is also possible to detect the control area internal noise on the basis of outputs of a plurality of microphone arrays (microphones) different in distance from a center position of the control area such as the detection microphone, the reference microphone array 81, the error microphone array 85, and the like.

In addition, in the control area internal noise detection unit 88, the control area internal noise may be detected by sound source position estimation or direction of arrival estimation (DOA) using a microphone array, or a combination of these technologies or the like. Note that any method may be used as a method of detecting the control area internal noise.

When the presence or absence of the control area internal noise is detected as described above, the control area internal noise detection unit 88 supplies the noise detection signal indicating the relevant detection result to the adaptive filter coefficient calculation unit 89.

(Adaptive Filter Coefficient Calculation Unit)

In the adaptive filter coefficient calculation unit 89, the filter coefficient of the adaptive filter is updated on the basis of a spatial frequency spectrum of an error signal and a spatial frequency spectrum of a reference signal multiplied by a spatial frequency spectrum of an estimated secondary path.

However, in a case where the noise detection signal indicating that the control area internal noise has been detected is supplied from the control area internal noise detection unit 88, the filter coefficient is not updated. In other words, in a case where the control area internal noise has been detected in the control area, the update of the filter coefficient is not performed.

For example, it is assumed that the time index is nₜ, the time frequency index is n_{tf}, and the spatial frequency spectrum of the error signal output from the spatial frequency analysis unit 87 is represented by S′ₙ^{err}(nₜ, n_{tf}) Here, n is the order of the spatial frequency.

At this time, a filter coefficient of the adaptive filter that minimizes a squared error ξ′(nₜ, n_{tf}) of the spatial frequency spectrum S′ₙ^{err}(nₜ, n_{tf}) of the error signal expressed in the following Formula (17) is calculated as a filter coefficient after update. Note that, in Formula (17), * indicates a complex conjugate.

[Formula 17]

ξ′(nₜ, n_{tf})=(S′ₙ^{err}(nₜ, n_{tf}))²=S′^{err}(nₜ, n_{tf})S′ₙ^{err}(nₜ, n_{tf}) (17)

In this case, an update equation expressed in the following Formula (18) is obtained similarly to the above-described method.

[Formula 18]

w (nₜ+1, n_{tf})=w(nₜ, n_{tf})+μS′ₙ^{err}(nₜ, n_{tf})X′ (18)

Note that, in Formula (18), w(nₜ, n_{tf}) indicates the filter coefficient before update, and w(nₜ+1, n_{tf}) indicates a filter coefficient after update. Furthermore, in Formula (18), μ indicates a step size and X′ is expressed by the following Formula (19).

[Formula 19]

X′=(S′ₙ^{ref}(nₜ, n_{tf})* (19)

In Formula (19), n indicates the order of the spatial frequency, and indicates the complex conjugate. Furthermore, S′ₙ^{ref} (nₜ, n_{tf}) indicates a spatial frequency spectrum of a reference signal which is an output of the spatial frequency analysis unit 83, and this spatial frequency spectrum S′ₙ^{ref} (nₜ, n_{tf}) is the spatial frequency spectrum S′ₙ(n_{tf}) in the above-described Formula (11). Moreover, αₙ indicates a spatial frequency spectrum of an estimated secondary path.

Therefore, for example, an operation to calculate a product of the spatial frequency spectrum S′ₙ^{ref} (nₜ, n_{tf}) and the spatial frequency spectrum αₙ of the estimated secondary path is performed in the estimated secondary path addition unit 84.

In the adaptive filter coefficient calculation unit 89, Formula (18) is calculated on the basis of the spatial frequency spectrum S′ₙ^{ref} (nₜ, n_{tf}) αₙ supplied from the estimated secondary path addition unit 84, the spatial frequency spectrum S′ₙ^{err} (nₜ, n_{tf}) of the error signal, and the filter coefficient w(nₜ, n_{tf}) before update, and the filter coefficient w(nₜ+1, n_{tf}) after update is calculated.

(Spatial Frequency Synthesis Unit)

The spatial frequency synthesis unit 91 performs spatial frequency synthesis of a spatial frequency spectrum of a speaker drive signal supplied from the adaptive filter unit 90 according to a shape of the speaker array 93.

For example, it is assumed that the order of the spatial frequency is n, the maximum order of the spatial frequency is N, and the spatial frequency spectrum of the speaker drive signal, which is an output of the adaptive filter unit 90, is represented by D′ₙ(n_{tf}).

At this time, for example, in a case where the speaker array 93 is a circular speaker array, the spatial frequency synthesis unit 91 performs the spatial frequency synthesis by calculating the following Formula (20).

[Formula 20]

D=EₛₚD′ (20)

Note that, in Formula (20), D indicates a vector of a time frequency spectrum of the speaker drive signal, which is an output of the spatial frequency synthesis unit 91, and Eₛₚ indicates a matrix including a circular harmonic function. Furthermore, D′ indicates a vector including the spatial frequency spectrum D′ₙ(n_{tf}) of the speaker drive signal which serves as an input to the spatial frequency synthesis unit 91.

In other words, the vector D′ is expressed by the following Formula (21), the matrix Eₛₚ is expressed by the following Formula (22), and the vector D is expressed by the following Formula (23).

$$\begin{matrix}[ Formula 21 ] & \\ {D}^{′} = [ \begin{matrix}{D}_{- N}^{′ } ( {n}_{tf} ) \\ {D}_{- N + 1}^{′ } ( {n}_{tf} ) \\ {D}_{- N + 2}^{′ } ( {n}_{tf} ) \\ ⋮ \\ {D}_{N}^{′ } ( {n}_{tf} )\end{matrix} ] & ( 21 ) \\ [ Formula 22 ] & \\ {E}_{sp} = [ \begin{matrix}{e}^{i ( - N ) {φ}_{0}} & {e}^{i ( - N + 1 ) {φ}_{0}} & … & {e}^{iN {φ}_{0}} \\ {e}^{i ( - N ) {φ}_{1}} & {e}^{i ( - N + 1 ) {φ}_{1}} & … & {e}^{iN {φ}_{1}} \\ ⋮ & ⋮ & ⋱ & ⋮ \\ {e}^{i ( - N ) {φ}_{L - 1}} & {e}^{i ( - N + 1 ) {φ}_{L - 1}} & … & {e}^{iN {φ}_{L - 1}}\end{matrix} ] & ( 22 ) \\ [ Formula 23 ] & \\ D = [ \begin{matrix}D ( 0 , {n}_{tf} ) \\ D ( 1 , {n}_{tf} ) \\ D ( 2 , {n}_{tf} ) \\ ⋮ \\ D ( L - 1 , {n}_{tf} )\end{matrix} ] & ( 23 )\end{matrix}$$

Note that n_{tf} indicates a time frequency index in Formulas (21) and (23), and 1 indicates a speaker index to identify a speaker constituting the speaker array 93, and I=0, 1, 2, . . . , and L−1 in Formulas (22) and (23). Furthermore, L indicates a speaker number which is the number of speakers constituting the speaker array 93. In particular, D(1, n_{tf}) in Formula (23) indicates a time frequency spectrum of the speaker drive signal.

Moreover, in Formula (22), i indicates a pure imaginary number, n (where n=−N, −N+1, . . . , and N) indicates the order of the spatial frequency, and φ₁ indicates an azimuth angle of a position of a speaker where a speaker index of the speaker array 93 is 1. The azimuth angle φ₁ corresponds to the above-described azimuth angle φ_{q} of the position of the microphone.

Furthermore, for example, in a case where the speaker array 93 is a spherical speaker array, the spatial frequency synthesis unit 91 performs spatial frequency synthesis by calculating the following Formula (24).

[Formula 24]

D=YₛₚD′ (24)

Note that, in Formula (24), D is a vector including the time frequency spectrum D(1, n_{tf}) expressed in Formula (23), and Yₛₚ is a matrix including a spherical harmonic function. Furthermore, D′ is a vector including the spatial frequency spectrum D′ₙ(n_{tf}) expressed in Formula (21).

The matrix Yₛₚ including the spherical harmonic function is expressed by the following Formula (25).

$$\begin{matrix} [ Formula 25 ] & \\ {Y}_{sp} = [ \begin{matrix}{Y}_{0}^{0} ( {θ}_{0} , {φ}_{0} ) & {Y}_{1}^{- 1} ( {θ}_{0} , {φ}_{0} ) & … & {Y}_{N}^{M} ( {θ}_{0} , {φ}_{0} ) \\ {Y}_{0}^{0} ( {θ}_{1} , {φ}_{1} ) & {Y}_{1}^{- 1} ( {θ}_{1} , {φ}_{1} ) & … & {Y}_{N}^{M} ( {θ}_{1} , {φ}_{1} ) \\ ⋮ & ⋮ & … & ⋮ \\ {Y}_{0}^{0} ( {θ}_{L - 1} , {φ}_{L - 1} ) & {Y}_{1}^{- 1} ( {θ}_{L - 1} , {φ}_{L - 1} ) & … & {Y}_{N}^{M} ( {θ}_{L - 1} , {φ}_{L - 1} )\end{matrix} ] & ( 25 )\end{matrix}$$

Note that θ₁ and φ₁ in Formula (25) indicate the elevation angle θ₁ and the azimuth angle φ₁ of the position of the speaker of the speaker array 93 corresponding to the elevation angle θ_{q} and the azimuth angle φ_{q} of the position of the microphone described above, respectively, and N and M represent the maximum orders of the spatial frequency. Furthermore, Yₙ^{m}(θ₁, φ₁) indicates a spherical harmonic function.

The spatial frequency synthesis unit 91 supplies the time frequency spectrum D(1, n_{tf}) of the speaker drive signal, obtained by the spatial frequency synthesis expressed in Formula (20) or (24), to the time frequency synthesis unit 92.

(Time Frequency Synthesis Unit)

The time frequency synthesis unit 92 performs time frequency synthesis on the time frequency spectrum D(1, n_{tf}) supplied from the spatial frequency synthesis unit 91 using inverse discrete Fourier transform (IDFT) to calculate a speaker drive signal d(1, nₜ) which is a time signal.

In other words, the calculation of the following Formula (26) is performed in the time frequency synthesis.

$$\begin{matrix}[ Formula 26 ] & \\ d ( l , {n}_{t} ) = \frac{1}{{M}_{dt}} {\sum }_{{n}_{tf} = 0}^{{M}_{dt} - 1} D ( l , {n}_{tf} ) {e}^{i \frac{2 π {n}_{t} {n}_{tf}}{{M}_{dt}}} & ( 26 )\end{matrix}$$

Note that, in Formula (26), nₜ indicates a time index, M_{dt} indicates the number of IDFT samples, and i indicates a pure imaginary number.

The time frequency synthesis unit 92 supplies the speaker drive signal d(1, nₜ) obtained by the time frequency synthesis to the speaker array 93, and outputs a sound based on the speaker drive signal d(1, nₜ).

<Description of Noise Canceling Process>

Next, an operation of the spatial noise control device 71 will be described.

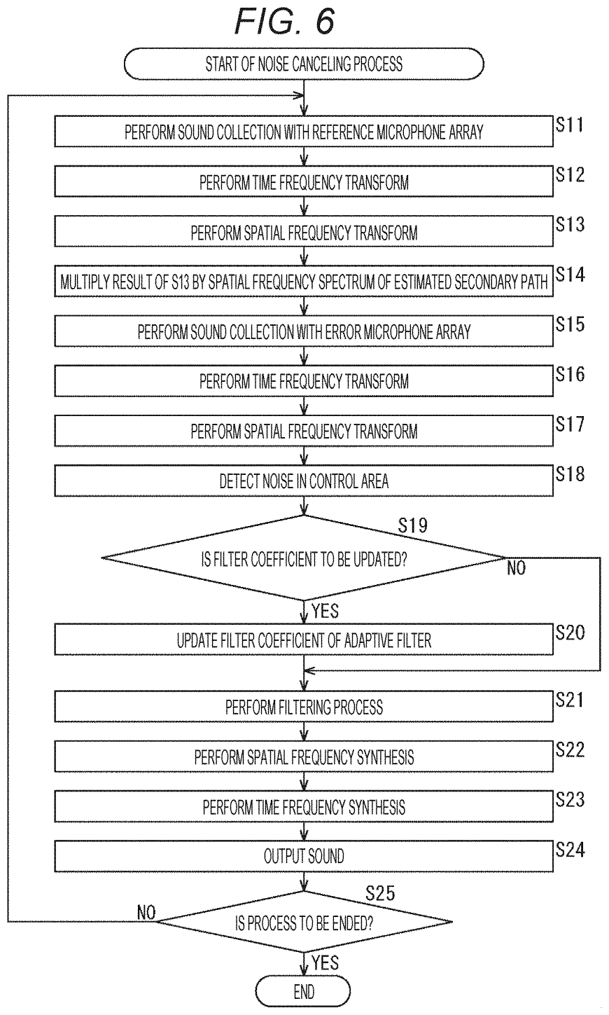

In other words, a noise canceling process to be performed by the spatial noise control device 71 will be described hereinafter with reference to a flowchart of FIG. 6.

In step S11, the spatial noise control device 71 performs sound collection at the reference microphone array 81. In other words, the reference microphone array 81 collects an ambient sound, and supplies a reference signal obtained as a result to the time frequency analysis unit 82.

In step S12, the time frequency analysis unit 82 performs time frequency transform on the reference signal supplied from the reference microphone array 81, and supplies a time frequency spectrum of the reference signal obtained as a result to the spatial frequency analysis unit 83. For example, the above-described calculation in Formula (9) is performed to calculate the time frequency spectrum in step S12.

In step S13, the spatial frequency analysis unit 83 performs spatial frequency transform on the time frequency spectrum supplied from the time frequency analysis unit 82, and supplies a spatial frequency spectrum obtained as a result to the estimated secondary path addition unit 84 and the adaptive filter unit 90. For example, the above-described calculation of Formula (10) or Formula (15) is performed to calculate the spatial frequency spectrum in step S13.

In step S14, the estimated secondary path addition unit 84 multiplies the spatial frequency spectrum supplied from the spatial frequency analysis unit 83 by the spatial frequency spectrum of the estimated secondary path, and supplies the spatial frequency spectrum obtained as a result to the adaptive filter coefficient calculation unit 89. For example, the spatial frequency spectrum S′ₙ^{ref} (nₜ, n_{tf}) αₙ expressed in the above-described Formula (19) is calculated in step S14.

In step S15, the spatial noise control device 71 performs sound collection at the error microphone array 85. In other words, the error microphone array 85 collects an ambient sound and supplies an error signal obtained as a result to the time frequency analysis unit 86.

In step S16, the time frequency analysis unit 86 performs time frequency transform on the error signal supplied from the error microphone array 85, and supplies a time frequency spectrum of the error signal obtained as a result to the spatial frequency analysis unit 87. For example, the calculation similar to that of Formula (9) described above is performed in step S16.

In step S17, the spatial frequency analysis unit 87 performs spatial frequency transform on the time frequency spectrum supplied from the time frequency analysis unit 86, and supplies a spatial frequency spectrum obtained as a result to the adaptive filter coefficient calculation unit 89. For example, the calculation similar to that of Formula (10) or Formula (15) described above is performed in step S17.

In step S18, the control area internal noise detection unit 88 detects control area internal noise on the basis of, for example, a sensor signal that is an output of a sensor such as a camera, an output of a detection microphone, the reference signal, the error signal, and the like, and supplies a noise detection signal indicating the detection result to the adaptive filter coefficient calculation unit 89.

In step S19, the adaptive filter coefficient calculation unit 89 determines whether or not to perform update of a filter coefficient of an adaptive filter on the basis of the noise detection signal supplied from the control area internal noise detection unit 88. For example, in a case where the noise detection signal is a signal indicating that no control area internal noise has been detected, it is determined to perform the update.

In a case where it is determined in step S19 to perform the update, the process proceeds to step S20.

In step S20, the adaptive filter coefficient calculation unit 89 calculates the filter coefficient of the adaptive filter on the basis of the spatial frequency spectrum from the estimated secondary path addition unit 84 and the spatial frequency spectrum from the spatial frequency analysis unit 87, and updates the filter coefficient. For example, the above-described calculation of Formula (18) is performed to update the filter coefficient in step S20.

The adaptive filter coefficient calculation unit 89 supplies the obtained filter coefficient after update to the adaptive filter unit 90, and thereafter, the process proceeds to step S21.

On the other hand, in a case where it is determined in step S19 not to perform the update, in other words, in a case where the control area internal noise has been detected in the control area, the process of step S20 is not performed, and thereafter, the process proceeds to step S21.

If it is determined in step S19 not to perform the update, or if the process of step S20 is performed, the process of step S21 is performed.

In other words, in step S21, the adaptive filter unit 90 performs a filtering process on the spatial frequency spectrum supplied from the spatial frequency analysis unit 83 using the filter coefficient of the adaptive filter supplied from the adaptive filter coefficient calculation unit 89.

The adaptive filter unit 90 supplies the spatial frequency spectrum of the speaker drive signal obtained by the filtering process to the spatial frequency synthesis unit 91.

In step S22, the spatial frequency synthesis unit 91 performs spatial frequency synthesis of the spatial frequency spectrum supplied from the adaptive filter unit 90, and supplies a time frequency spectrum of the speaker drive signal obtained as a result to the time frequency synthesis unit 92. For example, the above-described calculation of Formula (20) or Formula (24) is performed to calculate the time frequency spectrum in step S22.

In step S23, the time frequency synthesis unit 92 performs time frequency synthesis of the time frequency spectrum supplied from the spatial frequency synthesis unit 91, and supplies a speaker drive signal, which is a time signal obtained as a result, to the speaker array 93. For example, the above-described calculation of Formula (26) is performed to calculate the speaker drive signal in step S23.

In step S24, the speaker array 93 outputs a sound on the basis of the speaker drive signal supplied from the time frequency synthesis unit 92. Thus, the external noise in the noise canceling area is canceled (reduced) by the sound output from the speaker array 93.

In step S25, the spatial noise control device 71 determines whether or not to end the process.

In a case where it is determined in step S25 not to end the process yet, the process returns to step S11, and the above-described processing is repeated.

On the other hand, in a case where it is determined in step S25 to end the process, the noise canceling process is ended.

As described above, the spatial noise control device 71 generates the speaker drive signal by the filtering process using the filter coefficient of the adaptive filter, and outputs the sound that counteracts the external noise. At this time, the spatial noise control device 71 detects control area internal noise generated in the control area, and controls the update of the filter coefficient of the adaptive filter according to the detection result.

Since the control area internal noise is detected and the update of the filter coefficient of the adaptive filter is controlled according to the detection result in this manner, it is possible to suppress the divergence of the adaptive filter and to improve the noise canceling performance.

Further, the update of filter coefficient and the filtering process are performed in the spatial frequency domain in the spatial noise control device 71. In other words, the speaker drive signal of the sound to reduce, that is, cancel the external noise is generated by wavefront synthesis.

Therefore, a wavefront of the sound by which the external noise is counteracted (canceled) is obtained by the wavefront synthesis in the entire noise canceling area, and thus, it is possible to obtain the high noise canceling performance.

Furthermore, since the update of the filter coefficient and the filtering process are performed in the spatial frequency domain, it is possible to reduce the amount of calculation by diagonalizing transfer characteristics. Thus, the filter coefficient of the adaptive filter converges quickly so that it is possible to improve the noise canceling performance.

### Second Embodiment

<Configuration Example of Spatial Noise Control Device>

Note that the case where the present technology is applied to the feedforward ANC system has been described as an example as above, but it is of course possible to apply the present technology to a feedback ANC system. Hereinafter, a case where the present technology is applied to the feedback type ANC system will be described as an example.

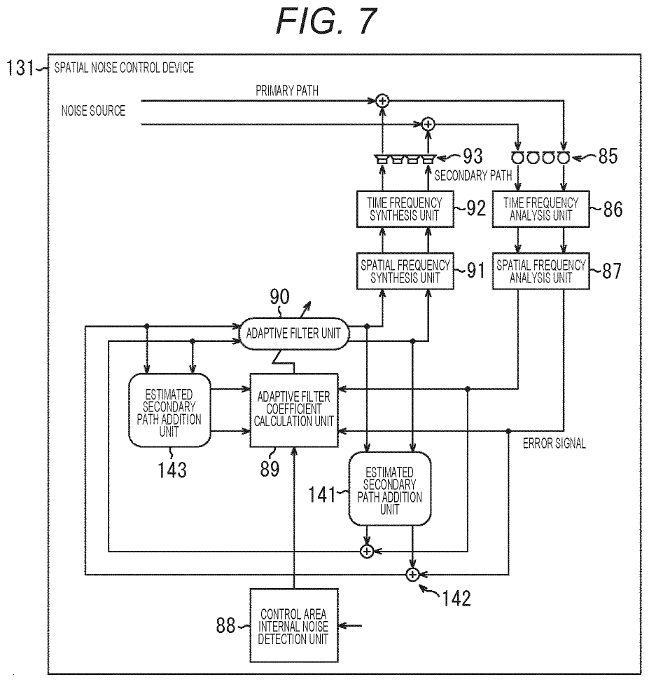

In such a case, a spatial noise control device is configured, for example, as illustrated in FIG. 7. Note that parts in FIG. 7 corresponding to those of the case in FIG. 3 will be denoted by the same reference signs, and the description thereof will be omitted as appropriate.

The spatial noise control device 131 illustrated in FIG. 7 includes the error microphone array 85, the time frequency analysis unit 86, the spatial frequency analysis unit 87, an estimated secondary path addition unit 141, an addition unit 142, an estimated secondary path addition unit 143, the control area internal noise detection unit 88, the adaptive filter coefficient calculation unit 89, the adaptive filter unit 90, the spatial frequency synthesis unit 91, the time frequency synthesis unit 92, and the speaker array 93.

In the spatial noise control device 131, a sound is collected only using the error microphone array 85 without using the reference microphone array 81.

Furthermore, a spatial frequency spectrum of an error signal obtained by the spatial frequency analysis unit 87 is supplied to the adaptive filter coefficient calculation unit 89 and the addition unit 142. Moreover, a spatial frequency spectrum of a speaker drive signal obtained by the adaptive filter unit 90 is supplied to the spatial frequency synthesis unit 91 and the estimated secondary path addition unit 141.

The estimated secondary path addition unit 141 corresponds to the estimated secondary path addition unit 84, multiplies the spatial frequency spectrum of the speaker drive signal supplied from the adaptive filter unit 90 by a spatial frequency spectrum of an estimated secondary path, and supplies a spatial frequency spectrum obtained as a result to the addition unit 142.

The addition unit 142 adds the spatial frequency spectrum of the error signal supplied from the spatial frequency analysis unit 87 and the spatial frequency spectrum supplied from the estimated secondary path addition unit 141, and supplies the obtained spatial frequency spectrum to the estimated secondary path addition unit 143 and the adaptive filter unit 90.

The estimated secondary path addition unit 143 corresponds to the estimated secondary path addition unit 84, multiplies the spatial frequency spectrum supplied from the addition unit 142 by the spatial frequency spectrum of the estimated secondary path, and supplies a spatial frequency spectrum obtained as a result to the adaptive filter coefficient calculation unit 89.

The adaptive filter coefficient calculation unit 89 calculates a filter coefficient of an adaptive filter on the basis of the spatial frequency spectrum from the estimated secondary path addition unit 143 and the spatial frequency spectrum of the error signal from the spatial frequency analysis unit 87 according to a noise detection signal supplied from the control area internal noise detection unit 88, and supplies the calculated filter coefficient to the adaptive filter unit 90.

The adaptive filter unit 90 uses the filter coefficient of the adaptive filter supplied from the adaptive filter coefficient calculation unit 89 to perform a filtering process on the spatial frequency spectrum supplied from the addition unit 142, thereby generating a spatial frequency spectrum of a speaker drive signal.

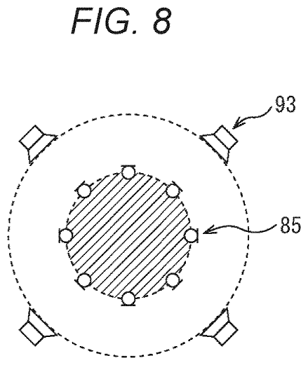

Since the reference microphone array 81 is not used when the spatial noise control device 131 is of the feedback type in this manner, a control area is, for example, an area formed by the error microphone array 85 as illustrated in FIG. 8, that is, an area surrounded by the error microphone array 85. Note that parts in FIG. 8 corresponding to those of the case in FIG. 7 will be denoted by the same reference signs, and the description thereof will be omitted as appropriate.

In the example illustrated in FIG. 8, the error microphone array 85 is arranged in an area surrounded by speakers of the speaker array 93.

In the spatial noise control device 131, an inner part of the error microphone array 85 with hatching, that is, an area of a part surrounded by the respective microphones is set as the control area, and noise generated in this control area is detected. Furthermore, regarding a noise canceling area, the area surrounded by the speaker array 93 is taken as the noise canceling area similarly to the case of the spatial noise control device 71.

<Description of Noise Canceling Process>

Subsequently, an operation of the spatial noise control device 131 will be described.

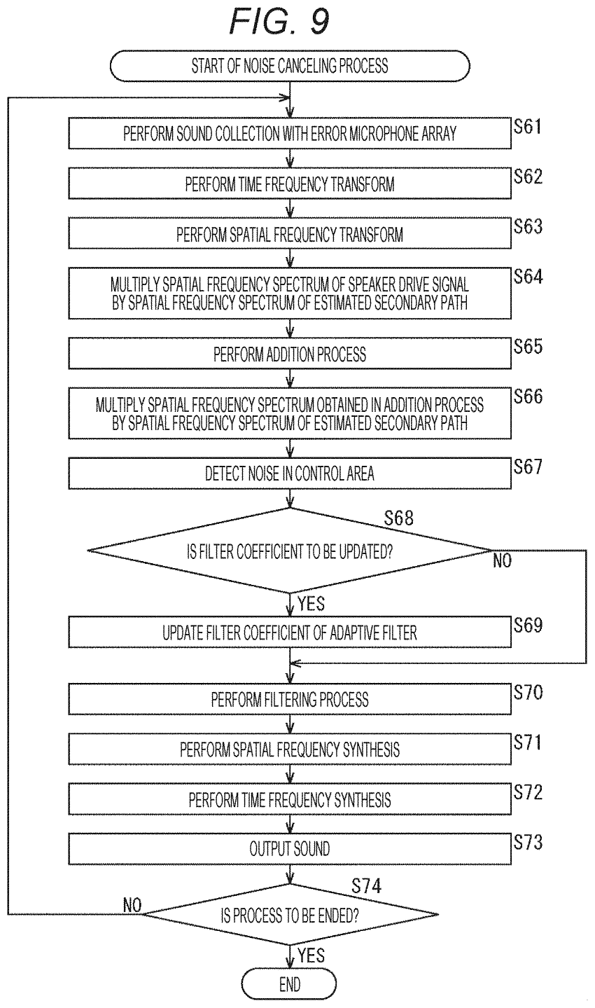

In other words, a noise canceling process to be performed by the spatial noise control device 131 will be described hereinafter with reference to a flowchart of FIG. 9.

When the noise canceling process is started, processes of steps S61 to S63 are performed. Since these processes are similar to the processes of steps S15 to S17 of FIG. 6, the description thereof will be omitted. However, in step S63, the spatial frequency spectrum of the error signal, obtained by spatial frequency transform, is supplied from the spatial frequency analysis unit 87 to the adaptive filter coefficient calculation unit 89 and the addition unit 142.

In step S64, the estimated secondary path addition unit 141 multiplies the spatial frequency spectrum of the speaker drive signal supplied from the adaptive filter unit 90 by the spatial frequency spectrum of the estimated secondary path, and supplies the spatial frequency spectrum obtained as the result to the addition unit 142.

In step S65, the addition unit 142 performs an addition process. In other words, the addition unit 142 adds the spatial frequency spectrum supplied from the spatial frequency analysis unit 87 and the spatial frequency spectrum supplied from the estimated secondary path addition unit 141, and supplies the obtained spatial frequency spectrum to the estimated secondary path addition unit 143 and the adaptive filter unit 90.

In step S66, the estimated secondary path addition unit 143 multiplies the spatial frequency spectrum supplied from the addition unit 142 by the spatial frequency spectrum of the estimated secondary path, and supplies the spatial frequency spectrum obtained as a result to the adaptive filter coefficient calculation unit 89.

When the process of step S66 is performed, thereafter, processes of steps S67 to S74 are performed, and the noise canceling process is ended. Since these processes are similar to the processes of steps S18 to S25 of FIG. 6, the description thereof will be omitted.

However, in step S69, the adaptive filter coefficient calculation unit 89 updates the filter coefficient of the adaptive filter on the basis of the spatial frequency spectrum from the estimated secondary path addition unit 143 and the spatial frequency spectrum from the spatial frequency analysis unit 87.

Furthermore, in step S70, the adaptive filter unit 90 uses the filter coefficient of the adaptive filter supplied from the adaptive filter coefficient calculation unit 89 to perform a filtering process on the spatial frequency spectrum supplied from the addition unit 142, thereby calculating a spatial frequency spectrum of a speaker drive signal. Moreover, the adaptive filter unit 90 supplies the obtained spatial frequency spectrum of the speaker drive signal to the spatial frequency synthesis unit 91 and the estimated secondary path addition unit 141.

As described above, the spatial noise control device 131 generates the speaker drive signal by the filtering process using the filter coefficient of the adaptive filter, and outputs the sound that counteracts the external noise. At this time, the spatial noise control device 131 detects control area internal noise generated in the control area, and controls the update of the filter coefficient of the adaptive filter according to the detection result.

Since the control area internal noise is detected and the update of the filter coefficient of the adaptive filter is controlled according to the detection result in this manner, it is possible to suppress the divergence of the adaptive filter and to improve the noise canceling performance.

<Application Example>

Meanwhile, the spatial noise control device 71 and the spatial noise control device 131 described above may be applied to, for example, a vehicle, a hospital, and the like.

In other words, for example, it is assumed that a speaker array including a large number of speakers and a microphone array including a large number of microphones are arranged in a cabin of a vehicle such as a passenger car.

At this time, the inside of the vehicle can be kept quiet by reducing (canceling) engine noise, road noise, and the like coming from the outside of a control area using the present technology. In particular, in this case, it is possible to suppress degradation in noise canceling performance using the present technology even in a case where control area internal noise is generated in the vehicle.

Furthermore, there is a shared room in the hospital where a plurality of hospitalized patients lives in the same room. In such a case, each hospitalized patient hears a sound of another patient and an ambient sound although a curtain blocks the field of view. Therefore, when the spatial noise control device to which the present technology is applied is installed on a partition and a predetermined area is surrounded by a microphone array or a speaker array, it is possible to cancel a sound from the outside of a control area. Thus, it is possible to secure a quiet space for each hospitalized patient. Moreover, when the spatial noise control device to which the present technology is applied is installed at parts of beds of all the patients, individual voices are mutually suppressed, which can be utilized for protection of privacy.

<Modification 1>

Note that the case where the reference microphone array 81, the error microphone array 85, and the speaker array 93 are spherical or circular has been described as a specific example as above, but shapes of the reference microphone array 81, the error microphone array 85, and the speaker array 93 may be any shape such as a linear shape.

For example, in a case where a reference microphone array, an error microphone array, and a speaker array are formed in a linear shape, the microphone array and the speaker array are arranged as illustrated in FIG. 10.

In the example illustrated in FIG. 10, a reference -microphone array 171 which is a linear microphone array, a speaker array 172 which is a linear speaker array, and an error microphone array 173 which is a linear microphone array are arrayed in a direction perpendicular to a direction in which microphones and speakers thereof are arrayed.

In other words, the reference microphone array 171 is arranged behind the speaker array 172, that is, in the upper side in the drawing, and the error microphone array 173 is arranged in front of the speaker array 172, that is, the lower side in the drawing. Here, a radiation direction of a sound of the speaker array 172 is the lower side in the drawing.

For example, the reference microphone array 171, the error microphone array 173, and the speaker array 172 are used in the spatial noise control device 71 of the feedforward type, instead of the reference microphone array 81, the error microphone array 85, and the speaker array 93.

In this case, a rectangular area R11 on the lower side of the reference microphone array 171 in the drawing is set as a control area, and an area, on the lower side of the speaker array 172 in the drawing, that is, on the side of the error microphone array 173, of the area R11 is set as a noise canceling area.

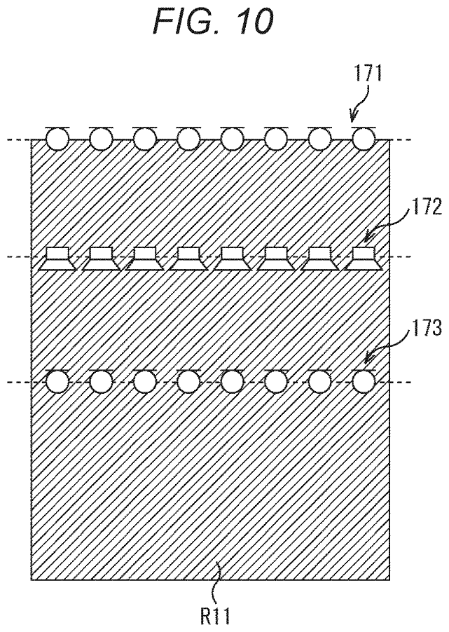

Furthermore, a linear microphone array or a linear speaker array may be arranged side by side in a rectangular frame shape, for example, as illustrated in FIG. 11.

In the example illustrated in FIG. 11, a rectangular frame-shaped speaker array 202 including four linear speaker arrays is arranged in an area surrounded by a rectangular frame-shaped reference microphone array 201 including four linear microphone arrays. Moreover, a rectangular frame-shaped error microphone array 203 including four linear microphone arrays is arranged in an area surrounded by the speaker array 202. In this example, the reference microphone array 201, the error microphone array 203, and the speaker array 202 are used, for example, in the spatial noise control device 71 of the feedforward type, instead of the reference microphone array 81, the error microphone array 85, and the speaker array 93.

In this case, an area R21 surrounded by the reference microphone array 201 is set as a control area, and an area surrounded by the speaker array 202 is set as a noise canceling area.

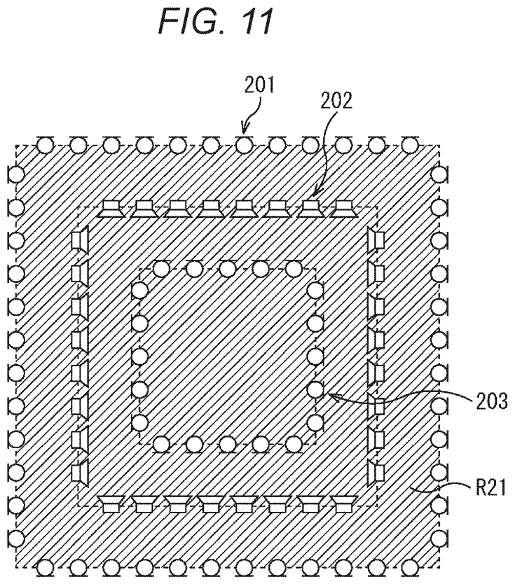

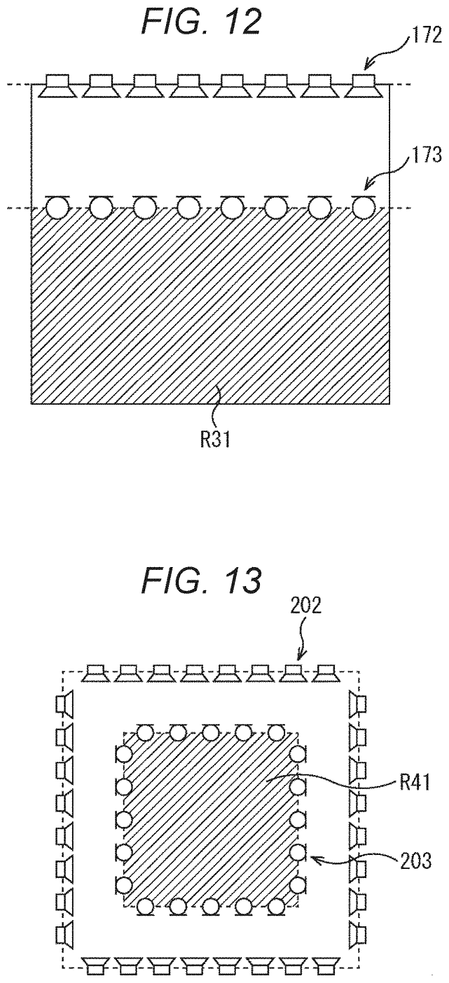

Similarly, in a case where a linear microphone array and a linear speaker array are used in the spatial noise control device 131 of the feedback type, a speaker array 172 is used instead of the speaker array 93 and the error microphone array 173 is used instead of the error microphone array 85 in the spatial noise control device 131, for example, as illustrated in FIG. 12. Note that parts in FIG. 12 corresponding to those of the case in FIG. 10 will be denoted by the same reference signs, and the description thereof will be omitted.

In the example illustrated in FIG. 12, a rectangular area R31 on the lower side of the error microphone array 173 in the drawing is set as a control area, and a rectangular area, on the lower side of the speaker array 172 in the drawing, that is, on the side of the error microphone array 173, is set as a noise canceling area.

Moreover, in a case where a microphone array and a speaker array formed in a rectangular frame shape are used in the spatial noise control device 131 of the feedback type, a speaker array 202 is used instead of the speaker array 93 and the error microphone array 203 is used instead of the error microphone array 85 in the spatial noise control device 131, for example, as illustrated in FIG. 13. Note that parts in FIG. 13 corresponding to those of the case in FIG. 11 will be denoted by the same reference signs, and the description thereof will be omitted.

In the example illustrated in FIG. 13, a rectangular area R41 surrounded by the error microphone array 203 is set as a control area, and a rectangular area surrounded by the speaker array 202 is set as a noise canceling area.

As described above, it is possible to improve the noise canceling performance by performing the above-described processing even in the case where the reference microphone array, the error microphone array, and the speaker array have the linear shape or the rectangular frame shape such that a filter coefficient of an adaptive filter is not updated in a case where control area internal noise is detected in a control area.

<Modification 2>

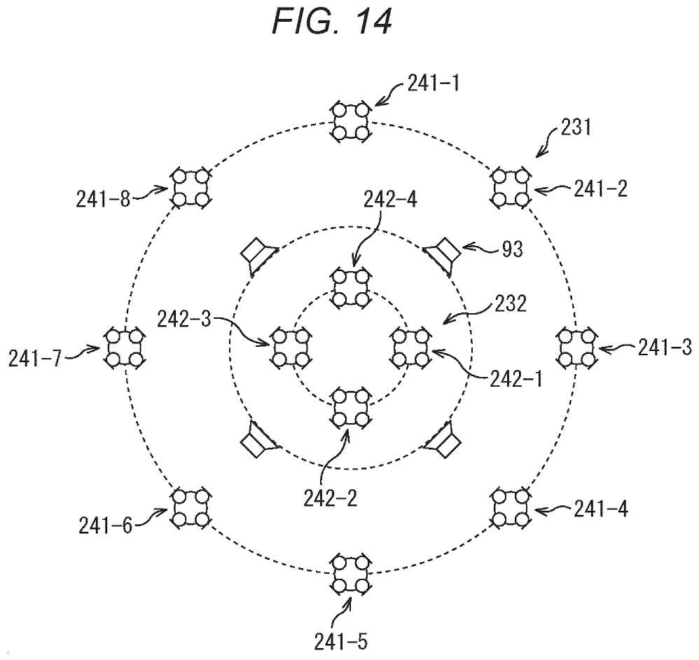

Furthermore, a spherical microphone array or a circular microphone array may be used instead of each of microphones constituting a reference microphone array and an error microphone array, for example, as illustrated in FIG. 14. Note that parts in FIG. 14 corresponding to those of the case in FIG. 3 will be denoted by the same reference signs, and the description thereof will be omitted as appropriate.

In the example illustrated in FIG. 14, the speaker array 93 is arranged in an area surrounded by a reference microphone array 231, and an error microphone array 232 is arranged in the area surrounded by the speaker array 93.

Furthermore, the reference microphone array 231 corresponds to the reference microphone array 81, and the error microphone array 232 corresponds to the error microphone array 85.

In this example, the reference microphone array 231 is configured using a plurality of microphone arrays 241-1 to 241-8. Note that the microphone arrays 241-1 to 241-8 will be simply referred to as microphone arrays 241 hereinafter in a case where it is unnecessary to particularly distinguish the microphone arrays 241-1 to 241-8.

Each of the microphone arrays 241 is a spherical microphone array or a circular microphone array obtained by arranging a plurality of microphones in a spherical or circular shape. Here, one circular microphone array is configured by arranging a plurality of microphone arrays 241 side by side in a circular shape, and this circular microphone array is used as the reference microphone array 231.

Similarly, the error microphone array 232 includes a plurality of microphone arrays 242-1 to 242-4. Note that the microphone arrays 242-1 to 242-4 will be simply referred to as microphone arrays 242 hereinafter in a case where it is unnecessary to particularly distinguish the microphone arrays 242-1 to 242-4.

Each of the microphone arrays 242 is a spherical microphone array or a circular microphone array obtained by arranging a plurality of microphones in a spherical or circular shape. Here, one circular microphone array is configured by arranging a plurality of microphone arrays 242 side by side in a circular shape, and this circular microphone array is used as the error microphone array 232.

In this example, in the spatial noise control device 71, the reference microphone array 231 is used instead of the reference microphone array 81, and the error microphone array 232 is used instead of the error microphone array 85.

Note that the reference microphone array 231 may be a spherical microphone array including a plurality of microphone arrays 241, and similarly, the error microphone array 232 may be a spherical microphone array including a plurality of microphone arrays 242.

When the reference microphone array 231 and the error microphone array 232 have such configurations, it is possible to suppress a leakage of control area internal noise from the inside of a control area to the reference microphone array 231. Furthermore, it is possible to suppress a leakage of an unnecessary sound, such as a sound wrapping around toward the reference microphone array 231 out of a sound for noise canceling output from the speaker array 93.

Since the reference microphone array 231 and the error microphone array 232 are configured using the microphone arrays 241 and the microphone arrays 242 which are the circular microphone arrays or the spherical microphone arrays, it is possible to provide a directivity to each of the microphone array 241 and the microphone array 242. Therefore, it is possible to further improve the noise canceling performance, for example, by controlling the microphone array 241 or the microphone array 242 such that the directivity is set toward the outside of a control area.

Although it is possible to provide the directivity by using the circular microphone array or the spherical microphone array, it is difficult to achieve a perfect directivity in practice, and it is not possible to completely prevent the leakage of the unnecessary sound only by controlling the directivity. However, when the technology of configuring the reference microphone array and the error microphone array using the plurality of microphone arrays in combination with the above-described spatial noise control device, it is possible to further improve the noise canceling performance.

Note that the control of the directivity of the microphone array is described in detail in, for example, “Meyer, Jens, and Gary Elko. “A highly scalable spherical microphone array based on an orthonormal decomposition of the soundfield”. Acoustics, Speech, and Signal Processing (IC ASSP), 2002 IEEE International Conference on. Vol. 2. IEEE, 2002”. and the like.

<Modification 3>

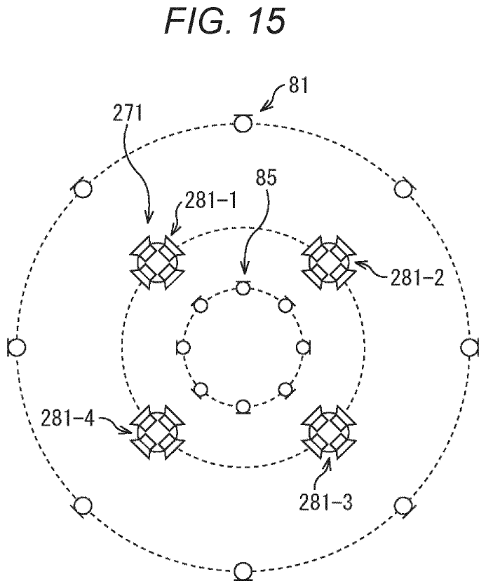

Furthermore, a spherical speaker array or a circular speaker array may be used as illustrated in FIG. 15, for example, instead of each of speakers constituting a speaker array that outputs a sound for noise canceling. Note that parts in FIG. 15 corresponding to those of the case in FIG. 3 will be denoted by the same reference signs, and the description thereof will be omitted as appropriate.

In the example illustrated in FIG. 15, a speaker array 271 is arranged in an area surrounded by the reference microphone array 81, and the error microphone array 85 is arranged in the area surrounded by the speaker array 271. Furthermore, the speaker array 271 corresponds to the speaker array 93.

In this example, the speaker array 271 includes a plurality of speaker arrays 281-1 to 281-4. Note that the speaker arrays 281-1 to 281-4 will be simply referred to as speaker arrays 281 hereinafter in a case where it is unnecessary to particularly distinguish the speaker arrays 281-1 to 281-4.

Each of the speaker arrays 281 is a spherical speaker array or a circular speaker array obtained by arraying a plurality of speakers in a spherical or circular shape. Here, one circular speaker array is configured by arranging the plurality of speaker arrays 281 side by side in a circular shape, and this circular speaker array is used as the speaker array 271. In this example, the speaker array 271 is used in the spatial noise control device 71 instead of the speaker array 93.

Note that the speaker array 271 may be a spherical speaker array including the plurality of speaker arrays 281.

When the speaker array 271 is configured using the plurality of speaker arrays 281, it is possible to reproduce a sound only within a noise canceling area surrounded by the speaker array 271 and to suppress a leakage of a sound to the outside of the noise canceling area.

For example, a sound, output from speakers, which are arranged to face the inside of the noise canceling area and constitute the speaker array 281 and wraps around toward the reference microphone array 81, can be counteracted by a sound output from speakers, which are arranged so as to face the outside of the noise canceling area and constitute the speaker array 281 outside the noise canceling area. When the speaker array 271 is used in this manner, it is possible to suppress the wraparound of the sound output from the speaker array 271 toward the reference microphone array 81 and to improve the noise canceling performance.

For example, if a plurality of circular speaker arrays or spherical speaker arrays is arrayed to form a speaker array, it is possible to suppress wraparound of a sound outside an area surrounded by the speaker array, but it is difficult to completely prevent the wraparound of the sound by itself in practice. However, when the technology of configuring the speaker array using the plurality of speaker arrays in combination with the above-described spatial noise control device, it is possible to further improve the noise canceling performance.

Note that the technique in which one speaker array is configured by arraying the plurality of speaker arrays to suppress wraparound of a sound is described in detail in, for example, “Samarasinghe, Prasanga N., et al. “3D soundfield reproduction using higher order loudspeakers”. 2013 IEEE International Conference on Acoustics, Speech and Signal Processing. IEEE, 2013”. and the like.

<Modification 4>

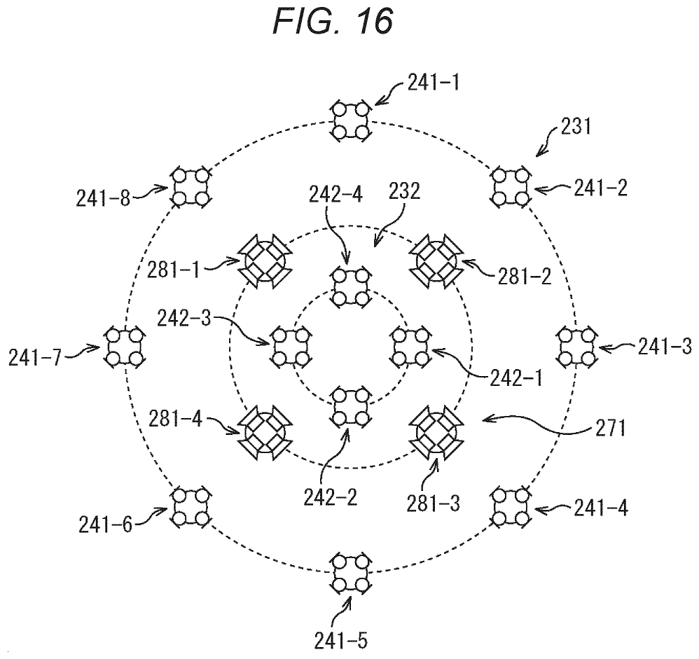

Moreover, the technology of arraying the plurality of circular microphone arrays or spherical microphone arrays to form one microphone array and the technology of arraying the plurality of circular speaker arrays or spherical speaker arrays to form one speaker array may be used in combination, for example, as illustrated in FIG. 16. Note that parts in FIG. 16 corresponding to those of the case in FIG. 14 or 15 will be denoted by the same reference signs, and the description thereof will be omitted as appropriate.

In this example, the reference microphone array 231, the error microphone array 232, and the speaker array 271 are used in the spatial noise control device 71, instead of the reference microphone array 81, the error microphone array 85, and the speaker array 93.

In the example illustrated in FIG. 16, a speaker array 271 is arranged in an area surrounded by the reference microphone array 231, and the error microphone array 232 is arranged in the area surrounded by the speaker array 271.

Note that the case where the technology in which one microphone array or speaker array is configured using the spherical or circular microphone arrays or speaker arrays is applied to the feedforward spatial noise control device has been described in the examples described with reference to FIGS. 14 to 16. However, such a technology in which one microphone array or speaker array is configured using the spherical or circular microphone arrays or speaker arrays may be applied to a feedback spatial noise control device.

<Modification 5>

In addition, the control area internal noise detection unit 88 may detect control area internal noise on the basis of a reference signal obtained by collecting a sound by a reference microphone array, for example.

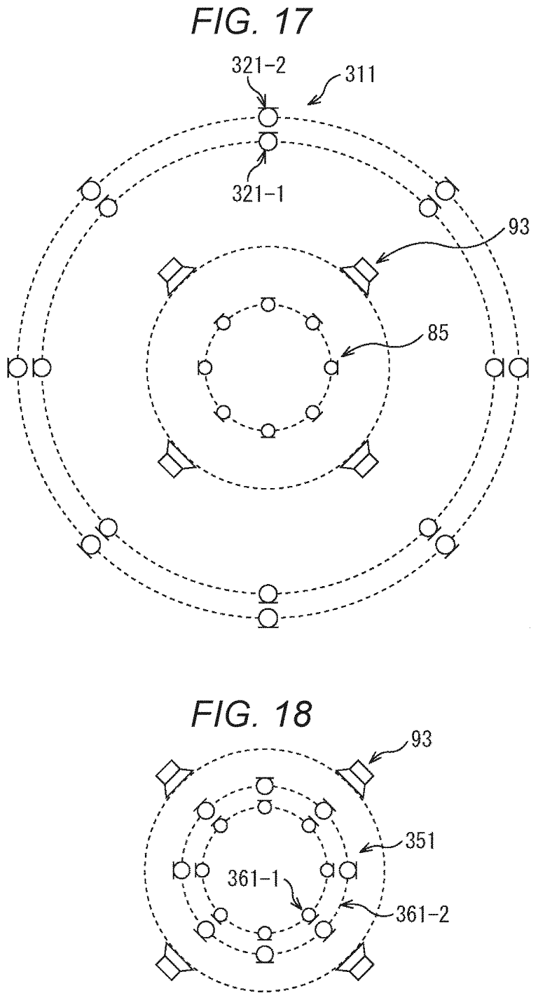

In such a case, for example, the reference microphone array is configured as illustrated in FIG. 17. Note that parts in FIG. 17 corresponding to those of the case in FIG. 3 will be denoted by the same reference signs, and the description thereof will be omitted as appropriate.

In the example of FIG. 17, a reference microphone array 311 is used in the spatial noise control device 71, instead of the reference microphone array 81. Furthermore, the speaker array 93 is arranged in an area surrounded by the reference microphone array 311, and the error microphone array 85 is arranged in the area surrounded by the speaker array 93.

The reference microphone array 311 is configured using a microphone array 321-1 which is a circular microphone array or a spherical microphone array, and a microphone array 321-2 which is a circular microphone array or a spherical microphone array.

In particular, here, a radius of the microphone array 321-1 is smaller than a radius of the microphone array 321-2, and thus, the microphone array 321-1 is arranged at a position closer to the speaker array 93 with respect to the microphone array 321-2.

In other words, a distance from a center position of a control area to the microphone array 321-1 is different from a distance from the center position of the control area to the microphone array 321-2.

Therefore, for example, when control area internal noise generated in the control area is collected by the reference microphone array 311, a sound pressure of a reference signal obtained by the microphone array 321-1 becomes larger than a sound pressure of a reference signal obtained by the microphone array 321-2.

On the other hand, when external noise propagating from the outside of the control area to the inside of the control area is collected by the reference microphone array 311, a sound pressure of a reference signal obtained by the microphone array 321-2 is larger than a sound pressure of a reference signal obtained by the microphone array 321-1.

Therefore, if the reference signal obtained by the reference microphone array 311 is supplied to the control area internal noise detection unit 88, the control area internal noise detection unit 88 can detect the control area internal noise by comparing the sound pressure of the reference signal obtained by the microphone array 321-1 with the sound pressure of the reference signal obtained by the microphone array 321-2.

Note that the error microphone array 85 may be configured using two or more microphone arrays different in distance from a center of a control area and the control area internal noise detection unit 88 may detect control area internal noise on the basis of an error signal supplied from the error microphone array 85, which is similar to the case of the reference microphone array 311.

Furthermore, there are two or more microphones different in distance from the center of the control area as microphones constituting these microphone arrays even for the reference microphone array 231 and the error microphone array 232, for example, illustrated in FIG. 16. Therefore, even when a reference signal or an error signal obtained by the reference microphone array 231 or the error microphone array 232 is used, it is possible to detect control area internal noise similarly to the case of the reference microphone array 311.

<Modification 6>

Moreover, control area internal noise can be detected on the basis of an error signal obtained by sound collection with an error microphone array even in the spatial noise control device 131.

In such a case, for example, the error microphone array is configured as illustrated in FIG. 18. Note that parts in FIG. 18 corresponding to those of the case in FIG. 7 will be denoted by the same reference signs, and the description thereof will be omitted as appropriate.

In the example of FIG. 18, an error microphone array 351 is used in the spatial noise control device 131, instead of the error microphone array 85. Furthermore, the error microphone array 351 is arranged in an area surrounded by the speaker array 93.

The error microphone array 351 is configured using a microphone array 361-1 which is a circular microphone array or a spherical microphone array, and a microphone array 361-2 which is a circular microphone array or a spherical microphone array.

In particular, here, a radius of the microphone array 361-1 is smaller than a radius of the microphone array 361-2, and thus, the microphone array 361-2 is arranged at a position closer to the speaker array 93 with respect to the microphone array 361-1.

In other words, a distance from a center position of a control area to the microphone array 361-1 is different from a distance from the center position of the control area to the microphone array 361-2.

Therefore, it is possible to detect control area internal noise by comparing a sound pressure of an error signal obtained by the microphone array 361-1 with a sound pressure of an error signal obtained by the microphone array 361-2, which is similar to the case described with reference to FIG. 17.

Therefore, in this example, the error signal obtained by the error microphone array 351 is supplied to the control area internal noise detection unit 88, the control area internal noise detection unit 88 detects the control area internal noise by comparing the sound pressure of the error signal obtained by the microphone array 361-1 with the sound pressure of the error signal obtained by the microphone array 361-2.

<Configuration Example of Computer>

Meanwhile, the above-described series of processes can be executed not only by hardware but also by software. In a case where the series of processes is executed by software, a program constituting the software is installed in a computer. Here, the computer includes a computer built in dedicated hardware and a general-purpose computer, for example, capable of executing various functions by installing various programs.

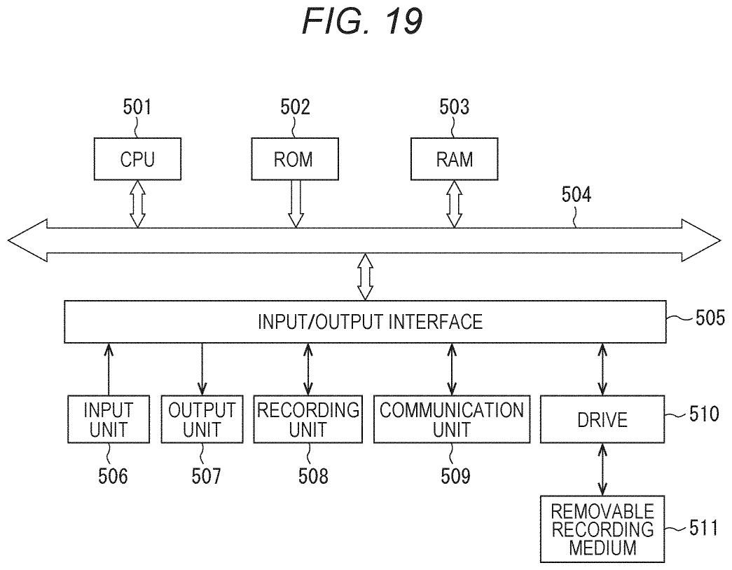

FIG. 19 is a block diagram illustrating a configuration example of hardware configuration of a computer that executes the above-described series of processes according to a program.

In the computer, a central processing unit (CPU) 501, a read only memory (ROM) 502, and a random access memory (RAM) 503 are mutually connected by a bus 504.

Moreover, an input/output interface 505 is connected to the bus 504. An input unit 506, an output unit 507, a recording unit 508, a communication unit 509, and a drive 510 are connected to the input/output interface 505.

The input unit 506 includes a keyboard, a mouse, a microphone array, an imaging element, and the like. The output unit 507 includes a display, a speaker array, and the like. The recording unit 508 includes a hard disk, a non-volatile memory, and the like. The communication unit 509 includes a network interface or the like. The drive 510 drives a removable recording medium 511 such as a magnetic disk, an optical disk, a magneto-optical disk, and a semiconductor memory.

In the computer configured as described above, for example, the CPU 501 executes a program recorded in the recording unit 508 in the state of being loaded on the RAM 503 via the input/output interface 505 and the bus 504, thereby performing the above-described series of processes.

The program executed by the computer (CPU 501) can be provided in the state of being recorded on, for example, the removable recording medium 511 as a package medium or the like. Furthermore, the program can be provided via a wired or wireless transmission medium such as a local area network, the Internet, and digital satellite broadcasting.

In the computer, the program can be installed in the recording unit 508 via the input/output interface 505 by mounting the removable recording medium 511 to the drive 510. Furthermore, the program can be received by the communication unit 509 via a wired or wireless transmission medium and installed in the recording unit 508. In addition, the program can be installed in advance in the ROM 502 and the recording unit 508.

Note that the program executed by the computer may be a program in which the processes are performed in a time-series order according to the order described in the present specification or may be a program in which the processes are performed in parallel or at necessary timing such as when a call is made.

Furthermore, embodiments of the present technology are not limited to the above-described embodiments, and various modifications can be made within a scope not departing from a gist of the present technology.

For example, the present technology can adopt a cloud computing configuration in which one function is shared and processed by a plurality of devices via a network.

Furthermore, each step described in the above-described flowcharts can be not only executed by one device but also shared and executed by a plurality of devices.

Moreover, in a case where a plurality of processes is included in one step, the plurality of processes included in one step can be not only executed by one device but also shared and executed by a plurality of devices.

Furthermore, the effects described in the present specification are merely examples and are not limited, and other effects may be present.

Moreover, the present technology can also be configured as follows.

(1) A signal processing device including: a noise detection unit that detects control area internal noise generated in a control area formed by a microphone array; and

a control unit that controls update of a filter coefficient of an adaptive filter, used to generate a signal of an output sound output by a speaker array, on the basis of a detection result of the control area internal noise in order to reduce external noise to a noise canceling area formed by the speaker array.

(2) The signal processing device described in (1), further including

an adaptive filter unit that generates the signal of the output sound on the basis of a signal obtained by sound collection using the microphone array and the filter coefficient.

(3) The signal processing device described in (2), in which

the adaptive filter unit performs a filtering process based on the signal obtained by the sound collection using the microphone array and the filter coefficient in a spatial frequency domain to generate the signal of the output sound.

(4) The signal processing device described in any one of (1) to (3), in which

the control unit does not perform the update of the filter coefficient in a case where the noise detection unit detects the control area internal noise.

(5) The signal processing device described in any one of (1) to (4), in which

the noise detection unit detects the control area internal noise on the basis of the signal obtained by sound collection using the microphone array.

(6) The signal processing device described in (5), in which

the noise detection unit detects the control area internal noise on the basis of each of signals obtained by sound collection using each of a plurality of microphone arrays which constitutes the microphone array and has different distances from a center position of the control area.

(7) The signal processing device described in (5), in which

the noise detection unit detects the control area internal noise on the basis of the signal obtained by the sound collection using the microphone array and a signal obtained by sound collection by another microphone array different from the microphone array in a distance from a center position of the control area.

(8) The signal processing device described in any one of (1) to (4), in which the noise detection unit detects the control area internal noise on the basis of a signal obtained by sound collection using a detection microphone arranged in the control area.

(9) The signal processing device described in any one of (1) to (8), in which

the microphone array is obtained by arranging a plurality of microphone arrays in a predetermined shape.

(10) The signal processing device described in any one of (1) to (9), in which

the speaker array is obtained by arranging a plurality of speaker arrays in a predetermined shape.

(11) The signal processing device described in any one of (1) to (10), in which

the control area is an area formed using a reference microphone array or an error microphone array as the microphone array.

(12) A signal processing method including the steps of:

detecting control area internal noise generated in a control area formed by a microphone array; and

controlling update of a filter coefficient of an adaptive filter, used to generate a signal of an output sound output by a speaker array, on the basis of a detection result of the control area internal noise in order to reduce external noise to a noise canceling area formed by the speaker array.

(13) A program for causing a computer to execute processing including the steps of:

detecting control area internal noise generated in a control area formed by a microphone array; and

controlling update of a filter coefficient of an adaptive filter, used to generate a signal of an output sound output by a speaker array, on the basis of a detection result of the control area internal noise in order to reduce external noise to a noise canceling area formed by the speaker array.

### REFERENCE SIGNS LIST

71 Spatial noise control device
81 Reference microphone array
85 Error microphone array
88 Control area internal noise detection unit
89 Adaptive filter coefficient calculation unit
90 Adaptive filter unit
93 Speaker array

1. A signal processing device comprising:
a noise detection unit that detects control area internal noise generated in a control area formed by a microphone array; and
a control unit that controls update of a filter coefficient of an adaptive filter, used to generate a signal of an output sound output by a speaker array, on a basis of a detection result of the control area internal noise in order to reduce external noise to a noise canceling area formed by the speaker array.

2. The signal processing device according to claim 1, further comprising
an adaptive filter unit that generates the signal of the output sound on a basis of a signal obtained by sound collection using the microphone array and the filter coefficient.

3. The signal processing device according to claim 2, wherein
the adaptive filter unit performs a filtering process based on the signal obtained by the sound collection using the microphone array and the filter coefficient in a spatial frequency domain to generate the signal of the output sound.

4. The signal processing device according to claim 1, wherein
the control unit does not perform the update of the filter coefficient in a case where the noise detection unit detects the control area internal noise.

5. The signal processing device according to claim 1, wherein
the noise detection unit detects the control area internal noise on a basis of a signal obtained by sound collection using the microphone array.

6. The signal processing device according to claim 5, wherein
the noise detection unit detects the control area internal noise on a basis of each of signals obtained by sound collection using each of a plurality of microphone arrays which constitutes the microphone array and has different distances from a center position of the control area.

7. The signal processing device according to claim 5, wherein
the noise detection unit detects the control area internal noise on a basis of the signal obtained by the sound collection using the microphone array and a signal obtained by sound collection by another microphone array different from the microphone array in a distance from a center position of the control area.

8. The signal processing device according to claim 1, wherein
the noise detection unit detects the control area internal noise on a basis of a signal obtained by sound collection using a detection microphone arranged in the control area.

9. The signal processing device according to claim 1, wherein
the microphone array is obtained by arranging a plurality of microphone arrays in a predetermined shape.

10. The signal processing device according to claim 1, wherein
the speaker array is obtained by arranging a plurality of speaker arrays in a predetermined shape.

11. The signal processing device according to claim 1, wherein
the control area is an area formed using a reference microphone array or an error microphone array as the microphone array.

12. A signal processing method comprising the steps of:
detecting control area internal noise generated in a control area formed by a microphone array; and
controlling update of a filter coefficient of an adaptive filter, used to generate a signal of an output sound output by a speaker array, on a basis of a detection result of the control area internal noise in order to reduce external noise to a noise canceling area formed by the speaker array.

13. A program for causing a computer to execute processing comprising the steps of:
detecting control area internal noise generated in a control area formed by a microphone array; and
controlling update of a filter coefficient of an adaptive filter, used to generate a signal of an output sound output by a speaker array, on a basis of a detection result of the control area internal noise in order to reduce external noise to a noise canceling area formed by the speaker array.
